(19) United States
(12) Patent Application Publication
(10) Pub. No.: US 2011/0279007 A1
(43) Pub. Date: Nov. 17, 2011

(54) LIGHT EMITTING ELEMENT, LIGHT EMITTING DEVICE, ILLUMINATING DEVICE, AND VEHICLE HEADLAMP

(75) Inventor: Katsuhiko KISHIMOTO, Osaka-Shi (JP)

(73) Assignee: SHARP KABUSHIKI KAISHA, Osaka-shi (JP)

(21) Appl. No.: 13/108,764

(22) Filed: May 16, 2011

(30) Foreign Application Priority Data
May 17, 2010 (JP) 2010-113473
Jun. 28, 2010 (JP) 2010-146321

(51) Int. Cl. B60Q 1/04; H01J 7/24; H01J 1/62

(52) U.S. Cl. 313/45; 313/498; 313/46

(57) ABSTRACT

The light emitting part is obtained by depositing fluorescent materials on a metal plate with a predetermined shape to form a fluorescent material film. The fluorescent material emits light upon irradiation with a laser beam.

This Nonprovisional application claims priority under 35 U.S.C. §119(a) on Patent Applications No. 2010-113473 filed in Japan on May 17, 2010 and No. 2010-146321 filed in Japan on Jun. 28, 2010, the entire contents of which are hereby incorporated by reference.

### TECHNICAL FIELD

The present invention relates to a light emitting element easily producible even when the light emitting element has a complicated shape, and to a light emitting device, an illuminating device, and a vehicle headlamp each including the light emitting element. Further, the present invention relates to a light emitting device serving as a high-luminance light source and to an illuminating device and a vehicle headlamp each including the light emitting device.

### BACKGROUND ART

In recent years, studies have been intensively carried out for a light emitting device that uses, as illumination light, fluorescence generated by a light emitting part which includes a fluorescent material. The light emitting part generates the fluorescence upon irradiation with excitation light, which is emitted from an excitation light source. The excitation light source used is a semiconductor light emitting element, such as a light emitting diode (LED), a laser diode (LD), or the like

Examples of a technique relating to such a light emitting device are lamps disclosed in Patent Literatures 1 and 2. In order to achieve a high-luminance light source, the lamp using such a light emitting device employs a laser diode as an excitation light source. Since a laser beam emitted from the laser diode is coherent and therefore highly directional, the laser beam can be collected without a loss so as to be used as excitation light. The light emitting device employing such a laser diode as the excitation light source (such a light emitting device may be hereinafter referred to as an LD light emitting device) is suitably applicable to a vehicle headlamp.

Further, Non-patent Literature 1 discloses a vehicle headlamp, which is an example of a technique for achieving a vehicle headlamp that employs a white LED emitting incoherent light.

A vehicle headlamp is required to meet safety standards such as it allows a driver to see an obstacle with a predetermined distance from the driver in order to assure the driver of a safe drive even at night.

In particular, a passing headlamp (i.e., a low beam) is required to meet a complicated light distribution property in order to prevent emitted light from disturbing an oncoming car. For this reason, the required light distribution property is achieved by positioning a light-shielding plate in front of a light source and blocking a part of light from the light source, as described in Patent Literature 3.

Another example of the technique relating to such a light emitting device is semiconductor illumination to substitute for currently used fluorescent lamps, incandescent lamps etc. In order to realize the semiconductor illumination, researches and developments have been actively made for increasing luminance and improving a luminous efficiency. A large market is expected for white LEDs for illumination in particular. For the purpose of illumination, not only an improvement in luminance and luminous efficiency of white LEDs but also an improvement in how colors are seen when the white LEDs are used in illumination, i.e. a color rendering property, are important.

In consideration of such a situation, in order to achieve a white LED structure excellent in the color rendering property, there is proposed a fluorescent material which emits white light upon irradiation with excitation light emitted from an LED capable of emitting blue or purple light (see Patent Literatures 4 and 5 for example).

The fluorescent material described in Patent Literatures 4 and 5 has a substrate capable of transmitting visible light and a semiconductor layer formed on the substrate, and achieves a white LED structure which emits more amount of red light component with high luminance from the semiconductor layer upon irradiation with blue or purple light from an LED and which is excellent in the color rendering property.

As described above, the fluorescent material described in Patent Literatures 4 and 5 is intended for achieving semiconductor illumination to substitute for current fluorescent lamps, incandescent lamps etc. Therefore, luminance required for the fluorescent material is substantially equal to or a bit higher than that of a conventional one.

### CITATION LIST

### Patent Literatures

### [Patent Literature 1]

Japanese Patent Application Publication, Tokukai No. 2005-150041 (published on Jun. 9, 2005)

### [Patent Literature 2]

Japanese Patent Application Publication, Tokukai No. 2003-295319 (published on Oct. 15, 2003)

### [Patent Literature 3]

Japanese Patent Application Publication, Tokukai No. 2004-87435 (published on Mar. 18, 2004)

### [Patent Literature 4]

Japanese Patent Application Publication, Tokukai No. 2005-19981 (published on Jan. 20, 2005)

### [Patent Literature 5]

Japanese Patent Application Publication, Tokukai No. 2008-124504 (published on May 29, 2008)

### Non-Patent Literature

### [Non-Patent Literature 1]

Masaru Sasaki: Hakushoku LED no Jidoushashoumei eno ouyou (Applications of white LEDs to automotive lightning devices), OYOBUTURI, Vol. 74, No. 11, pp. 1463-1466 (2005)

### SUMMARY OF INVENTION

### Technical Problem

In order that a conventional fluorescent material structure achieves white light with further higher luminance, one possible option is to use excitation light from a laser diode, instead of excitation light from an LED. By achieving a laser illumination light source which uses a laser beam from a laser diode as excitation light to excite a minute light emitting part including fluorescent materials, there may be a possibility to achieve a high-luminance light source which has not existed so far.

However, the inventor of the present invention and the inventor's colleagues have diligently studied and found that in a case where a laser beam is used as excitation light, excitation light which has been emitted to a minute light emitting part, i.e. a light emitting part with a minute area and absorbed therein and which is converted into heat without being converted into fluorescence easily increases the temperature of the light emitting part, and consequently the increase in the temperature of the light emitting part causes deterioration in properties of the light emitting part and damage of the light emitting part due to heat.

In particular, exciting a minute light emitting part with a high-power laser beam, i.e. exciting a light emitting part with high power density raises a problem that the light emitting part deteriorates greatly.

One of the reasons for deterioration of the light emitting part is an increase in temperature at an irradiated region and its neighbors (which may hereinafter referred to as a “temperature-increase region”) in the light emitting part irradiated with excitation light. When high power excitation light is emitted from a laser diode to the light emitting part but the irradiated region of the light emitting part is not subjected to a heat release process, there is a case where the temperature of the temperature-increase region exceeds 1,000° C. immediately after the excitation light is emitted. Consequently, only the temperature-increase region of the light emitting region partially suffers an extremely high temperature, which raises a problem of rapid deterioration of the temperature-increase region.

Therefore, in order to achieve a bright and long-life light source capable of exciting a minute light emitting part including a fluorescent material with high-power excitation light and preventing deterioration of the light emitting part, it is necessary to prevent the temperature of the temperature-increase region on the radiated region and its neighbors from increasing.

Further, in the conventional art, light emitted from the light source is partially blocked by a light shielding plate, so that a utilization ratio of light drops. In order to prevent the drop in the utilization ratio of light, it is desirable that a light emitting plane of the light emitting part which plane emits light is designed to have a shape meeting a predetermined light distribution property, but such shape is complicated. Further, use of a laser diode allows the light emitting part to be very small and thin. Accordingly, there arises a problem that when producing a very small and thin light emitting part, it would be difficult to take such a complicated shape into consideration. This problem is found for the first time by the inventor of the present invention and the inventor's colleagues, and has not been specifically mentioned in any known documents as long as the inventor and the colleagues know.

When a resin serving as a fluorescent material holding substance in which fluorescent materials are dispersed in resin is physically or chemically scraped in order to achieve a light emitting part having the aforementioned shape, particulate fluorescent materials also drop, making it difficult to form the light emitting part in a predetermined shape. If the light emitting part is required to be small and thin, forming the light emitting part in a predetermined shape is particularly difficult.

In the conventional art, it is possible to form a light emitting part in a predetermined shape by pouring, into a mold with the predetermined shape, a resin in which fluorescent materials are dispersed, and then heating and curing the resin. However, this technique requires molds with different shapes and sizes in order to form light emitting parts with different shapes and sizes. That is, when forming a small light emitting part, it is necessary to prepare a special mold for the light emitting part.

Further, since the resin is poured into a mold, facilitation of the pouring normally requires use of a mold with a predetermined thickness. Therefore, when producing a very thin (e.g. 1 mm in thickness) light emitting part, it is necessary to carry out a thinning process such as polishing after the resin has been poured into the mold. That is, in the conventional art, it is particularly difficult to easily produce a very small and thin light emitting part.

That is, in the conventional art, even when a light emitting part in a predetermined shape is produced using a mold, the production is time-consuming and troublesome, and so it is not easy to produce a small and thin light emitting part with a predetermined shape.

As described above, in the conventional art, it is difficult to easily produce a light emitting part with a complicated shape (desired shape). In particular, it is difficult to produce a very small and thin light emitting part used as a high luminance light source.

Although Patent Literatures 4 and 5 describe formation of a fluorescent material film on a substrate, Patent Literatures 4 and 5 neither disclose nor suggest that the substrate is conductive. This is because the techniques of Patent Literatures 4 and 5 are intended for providing a fluorescent material which is excellent in a color rendering property and is capable of emitting white light, and are not intended for facilitating production of a very small light emitting part with desired shape.

The present invention was made in view of the foregoing problems. An object of the present invention is to provide: a light emitting element which has high luminance and long life and which can be easily produced even when it has a complicated shape; and a light emitting device, an illuminating device, and a vehicle headlamp each including the light emitting element. Another object of the present invention is to provide: a light emitting device which prevents an increase in temperature of a temperature-increase region on a light emitting part irradiated with excitation light and prevents deterioration in characteristics or damage due to heat in the light emitting part so as to achieve a light source with high luminance and long life; and an illuminating device and a vehicle headlamp each including the light emitting device.

### Solution to Problem

In order to solve the foregoing problems, a light emitting element of the present invention includes: a conductive member with a predetermined shape; and at least one fluorescent material film on the conductive member, the at least one fluorescent material film being made by depositing on the conductive member a fluorescent material for emitting light upon irradiation with excitation light.

In the light emitting element with the above arrangement, the conducting member has a predetermined shape and the fluorescent material film is formed on the conducting member. The conducting member is made of a metal for example. Designing the conducting member to have a shape corresponding to a shape meeting a predetermined light distribution property (predetermined shape) can be made easily by a conventional method even if the conducting member is required to be small and have a complicated shape.

Since the light emitting element can be produced only by depositing fluorescent materials on the easily shapable conducting member to form the fluorescent material films, the light emitting element with a desired shape (e.g. complicated shape) can be easily realized even if the light emitting element is required to be small. Consequently, the light emitting element has a high utilization ratio of light. Further, since the light emitting element can be made small, the light emitting element can achieve high luminance.

Further, since the conducting member generally has high thermal conductivity, heat generated in the light emitting element can be released to the outside of the light emitting element via the conducting member. This enables preventing an increase in temperature of the light emitting element due to irradiation with excitation light. Consequently, the light emitting element can achieve a long life.

In order to solve the foregoing problems, a light emitting device of the present invention includes: a light emitting part including an irradiated surface including an irradiated area to be irradiated with excitation light; and a heat conducting member having higher thermal conductivity than the light emitting part, the heat conducting member having two ends, one end of which is embedded in the light emitting part in such a manner as to be positioned behind the irradiated region when seen from an incoming direction of the excitation light.

“Excitation light” used herein includes excitation light emitted from a laser diode and excitation light emitted from a light emitting diode.

In the light emitting device, when the light emitting part is irradiated with excitation light, the light emitting part emits light. When the light emitting part is irradiated with excitation light, heat is generated from the irradiated region irradiated with the excitation light, and the heat is released via the heat conducting member embedded in the light emitting part in such a manner as to be positioned behind the irradiated region when seen from an incoming direction of the excitation light.

Since the increase in temperature of the irradiated region in the light emitting part irradiated with the excitation light is prevented as above, it is possible to achieve a long-life light source. That is, the light emitting device of the present invention can serve as a light source with high luminance and high reliability.

### Advantageous Effects of Invention

As described above, the light emitting element of the present invention includes: a conductive member with a predetermined shape; and at least one fluorescent material film on the conductive member, the at least one fluorescent material film being made by depositing on the conductive member a fluorescent material for emitting light upon irradiation with excitation light.

Accordingly, the present invention provides a light emitting element with high luminance and long life, which can be easily produced even if the light emitting element is required to have a complicated shape.

As described above, the light emitting device of the present invention includes: a light emitting part including an irradiated surface including an irradiated area to be irradiated with excitation light; and a heat conducting member having higher thermal conductivity than the light emitting part, the heat conducting member having two ends, one end of which is embedded in the light emitting part in such a manner as to be positioned behind the irradiated region when seen from an incoming direction of the excitation light.

Accordingly, the light emitting device of the present invention can prevent an increase in temperature of a temperature-increase region on a light emitting part irradiated with excitation light and prevent deterioration in characteristics of the light emitting part or damage of the light emitting part due to heat, thereby serving as a light source with super high luminance and long life.

### BRIEF DESCRIPTION OF DRAWINGS

FIG. 1 is a perspective view illustrating the shape of a light emitting part in accordance with one embodiment of the present invention.

FIG. 2 is a cross sectional view illustrating a configuration of a headlamp in accordance with one embodiment of the present invention.

FIG. 3 is a view illustrating a positional relation between exit end parts and a light emitting part of an optical fiber included in a headlamp in accordance with one embodiment of the present invention.

FIG. 4 is a cross sectional view illustrating a modification example of a method of positioning a light emitting part in a headlamp in accordance with one embodiment of the present invention.

FIG. 5 is a perspective view illustrating a positional relation among a convex lens, a light shielding plate, and a light emitting part.

FIG. 6 is a view illustrating light distribution properties to be met by a headlamp in accordance with one embodiment of the present invention. (a) of FIG. 6 illustrates a light distribution property required for a passing headlamp for an automobile. (b) of FIG. 6 is a table showing illuminance specified by light distribution property standards for the passing headlamp.

FIG. 7 is a view explaining a configuration of a light emitting part in accordance with one embodiment of the present invention. (a) of FIG. 7 illustrates a cross section of a metal plate. (b) of FIG. 7 explains how to produce the light emitting part.

FIG. 8 is a view explaining an example of a test system in which a light emitting part in accordance with one embodiment of the present invention is produced.

FIG. 9 is a graph showing a chromaticity range of a white color required for a headlamp.

FIG. 10 is a cross sectional view explaining an example of a configuration or a material of a light emitting part in accordance with one embodiment of the present invention. (a) of FIG. 10 illustrates a cross section of the light emitting part illustrated in FIG. 1. (b)-(f) of FIG. 10 illustrate cross sections of modification examples of the light emitting part illustrated in FIG. 1.

FIG. 11 is a view explaining release of heat from a light emitting part in accordance with one embodiment of the present invention. (a) of FIG. 11 illustrates how heat is propagated in a light emitting part serving as a Comparative Example. (b) of FIG. 11 illustrates how heat is propagated in a light emitting part in accordance with one embodiment of the present invention.

FIG. 12 is a view schematically illustrating a configuration of a headlamp which is a modification example in accordance with one embodiment of the present invention.

FIG. 13 is a view illustrating shapes of modification examples of a light emitting part in accordance with one embodiment of the present invention. (a)-(c) of FIG. 13 illustrate shapes of modification examples of the light emitting part.

FIG. 14 is a view specifically illustrating a configuration of a laser diode included in a headlamp in accordance with one embodiment of the present invention. (a) of FIG. 14 schematically illustrates a circuit diagram of the laser diode. (b) of FIG. 14 perspectively illustrates a fundamental structure of the laser diode.

FIG. 15 is a cross sectional view illustrating a configuration of a headlamp in accordance with one embodiment of the present invention.

FIG. 16 is a view illustrating a first example of connection between a light emitting part and a heat-releasing supporter. (a) of FIG. 16 is a cross sectional view of the connection, and (b) of FIG. 16 is an elevation view of the connection.

FIG. 17 is a view illustrating a second example of connection between a light emitting part and a heat-releasing supporter.

FIG. 18 is a view illustrating a third example of connection between a light emitting part and a heat-releasing supporter. (a) of FIG. 18 is a cross section of the connection and (b) of FIG. 18 is an elevation view of the connection.

FIG. 19 is a view illustrating a fourth example of connection between a light emitting part and a heat-releasing supporter.

FIG. 20 is a view illustrating a fifth example of connection between a light emitting part and a heat-releasing supporter. (a) of FIG. 20 is a cross section of the connection and (b) of FIG. 20 is an elevation view of the connection.

FIG. 21 is a view specifically illustrating examples of a cooling device. (a) of FIG. 21 illustrates a first example of the cooling device, (b) of FIG. 21 illustrates a second example of the cooling device, and (c) of FIG. 21 illustrates a third example of the cooling device.

FIG. 22 is an elevation view specifically illustrating a light emitting part and a heat-releasing supporter.

FIG. 23 is a graph showing a relation between a cross sectional area of a heat-releasing supporter and an increase in temperature of a light emitting part.

FIG. 24 is a view schematically illustrating appearances of a light emitting unit included in a laser downlight in accordance with one embodiment of the present invention and a conventional LED downlight.

FIG. 25 is a cross sectional view illustrating a ceiling where the laser downlight is installed.

FIG. 26 is a cross sectional view of the laser downlight.

FIG. 27 is a cross sectional view illustrating a modification example of how to install the laser downlight.

FIG. 28 is a cross sectional view of a ceiling where the LED downlight is installed.

FIG. 29 is a table in which specs of the laser downlight and the conventional LED downlight are compared.

### DESCRIPTION OF EMBODIMENTS

### Embodiment 1

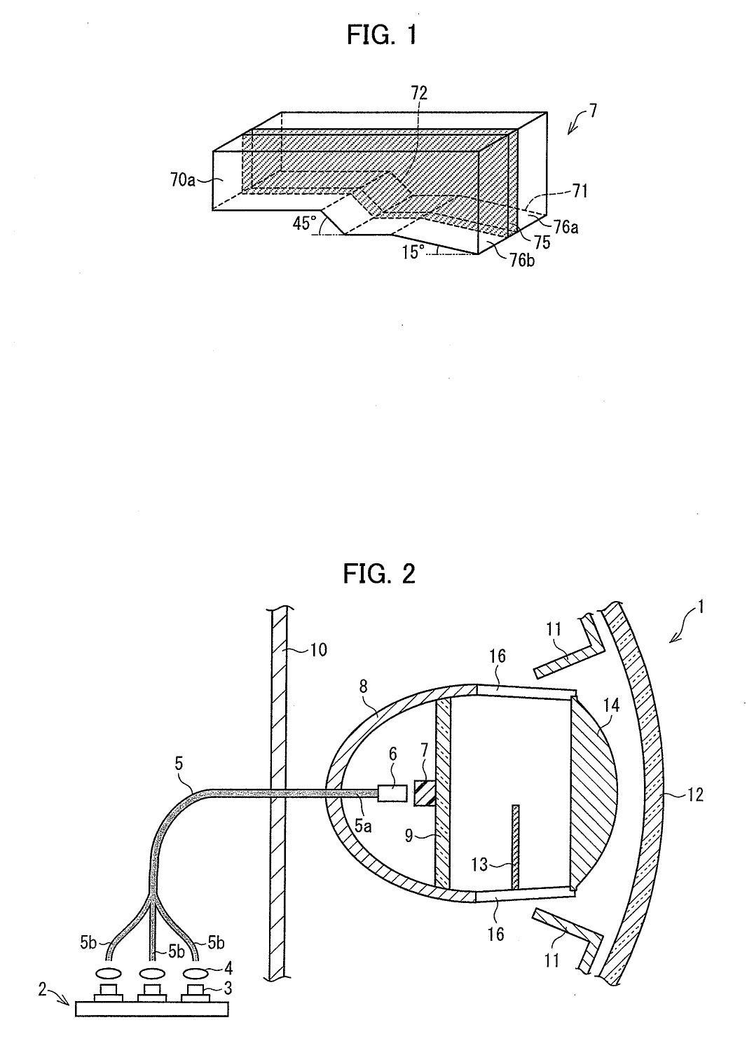

The following explains an embodiment of the present invention with reference to FIGS. 1-14. In the present embodiment, a headlamp 1 (vehicle headlamp) serving as a passing headlamp for automobile is described as an example of an illuminating device of the present invention. Note, however, that the illuminating device of the present invention can be achieved also as a headlamp for a vehicle other than the automobile or for a moving object other than the automobile (e.g., a person, a vessel, an airplane, a submersible vessel, or a rocket), as long as the illuminating device meets the light distribution property standards or can be achieved as other illuminating device. Examples of the other illuminating device include a search light, a projector, and lighting equipment for housing.

### (Configuration of Headlamp 1)

FIG. 2 is a view schematically illustrating how the headlamp 1 of the present embodiment is configured. As illustrated in FIG. 2, the headlamp 1 includes a laser diode array (excitation light source) 2, aspheric lenses 4, an optical fiber 5, a ferrule 6, a light emitting part (light emitting element) 7, a reflection mirror 8, a transparent plate 9, a housing 10, an extension 11, a lens 12, a light shielding plate 13, a convex lens 14, and a lens holder 16. The laser diode array 2, the optical fiber 5, the ferrule 6, and the light emitting part 7 constitute a fundamental structure of a light emitting device. The headlamp 1 is a projector-type headlamp, and therefore includes the convex lens 14. The present invention can be applied also to another kind of headlamp, such as a semi-shield beam headlamp. In this case, the convex lens 14 can be omitted.

The laser diode array 2 serves as an excitation light source that emits excitation light, and has a plurality of laser diodes (laser diode elements) 3 provided on a substrate. The laser diodes (excitation light sources) 3 emit laser beams, respectively. Note here that the number of the laser diodes 3 serving as the excitation light sources does not necessarily have to be plural, and therefore it is possible to employ only one laser diode 3. Note however that, in order to obtain a high-power laser beam, it is preferable to employ a plurality of laser diodes 3.

Each of the laser diodes 3 includes a chip on which one luminous point is provided. For example, each of such laser diodes 3 emits a laser beam at a wavelength of 405 nm (bluish purple), and its output is 4.0 W, operating voltage is 5 V, and operating current is 0.6 A. Each of the laser diodes 3 is sealed in a package that is 5.6 mm in diameter. A wavelength of the laser beam emitted from each of the laser diodes 3 is not limited to 405 nm, as long as the laser beam has a peak wavelength falling within a range of not less than 380 nm but not more than 470 nm. Further, in a case where it is possible to prepare a good-quality laser diode, for short wavelengths, which emits a laser beam at a wavelength shorter than 380 nm, such a laser diode can also be employed as each of the laser diodes 3 of the present embodiment.

In the present embodiment, a laser diode is employed as an excitation light source. Alternatively, a light emitting diode may be used.

The aspheric lenses 4 are lenses for guiding laser beams (excitation light) emitted from the laser diodes 3, in such a way that the laser beams enter an entrance end part 5b which is one end of the optical fiber 5. As each of the aspheric lenses 4, FLKN1 405 (manufactured by ALPS ELECTRIC CO., LTD.) can be used, for example. The aspheric lenses 4 are not particularly limited in shape and material as long as they have the foregoing function, but preferably have a high transmittance with respect to light at and around a wavelength of 405 nm which is the wavelength of the excitation light and are made of heat-stable materials.

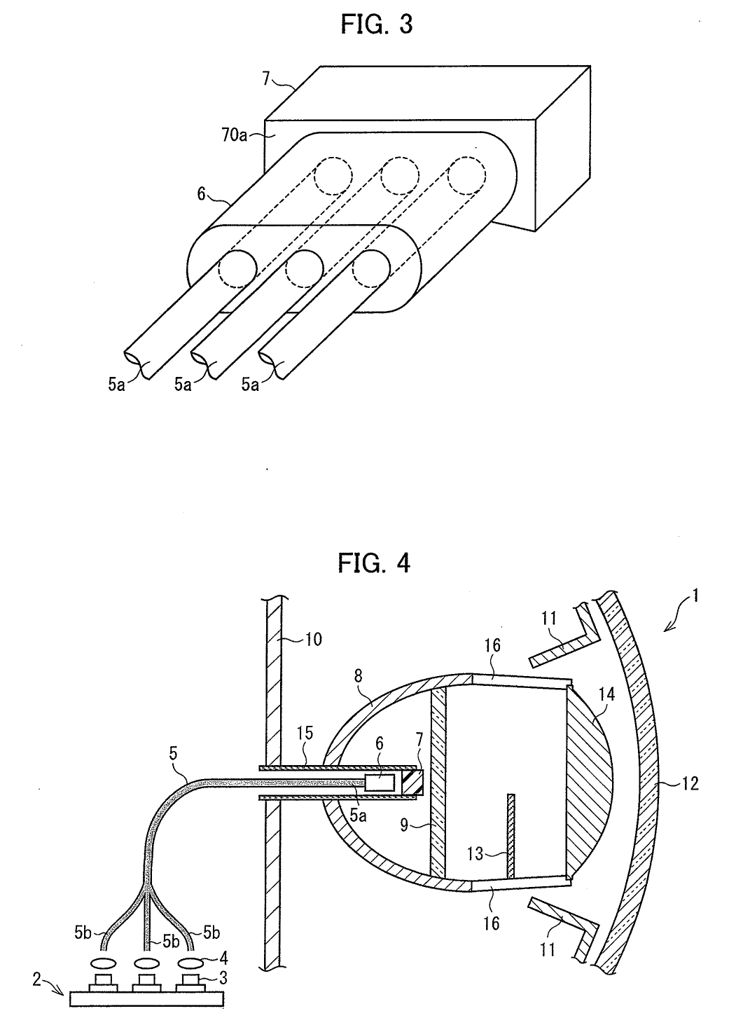

The optical fiber 5 is a light guide for guiding, to the light emitting part 7, laser beams emitted from the laser diodes 3. The optical fiber 5 is constituted by a bundle of a plurality of optical fibers. The optical fiber 5 has a plurality of entrance end parts 5b and a plurality of exit end parts 5a. The optical fiber 5 receives the laser beams through the plurality of entrance end parts 5b, and emits, through the exit end parts 5a, the laser beams received through the plurality of entrance end parts 5b. The plurality of exit end parts 5a emit laser beams toward respective different regions on a laser beam-irradiated surface (light receiving surface) 70a of the light emitting part 7 (refer to FIG. 3). To be more specific, the plurality of exit end parts 5a emit laser beams in such a way that light with the highest intensity in light intensity distribution of each of the laser beams is emitted to different regions of the light emitting part 7.

Herein, a laser beam emitted from one exit end part 5a reaches the laser beam-irradiated surface 70a of the light emitting part 7 while broadening at a predetermined angle. When laser beams are emitted from a plurality of exit end parts 5a, a plurality of irradiated regions are formed on the laser-beam irradiate surface 70a. Consequently, even when a plurality of exit end parts 5a of the optical fiber 5 are aligned on a plane parallel to the laser-beam irradiated surface 70a, there may be a case where the regions irradiated with the laser beams from the exit end parts 5a overlap each other.

Also in this case, by designing the exit end parts 5a to emit light with the highest intensity in light intensity distribution of each of the laser beams (central portions (portions with the maximum light intensities) of irradiated regions formed on the laser-beam irradiated surface 70a by the respective laser beams) to different regions of the laser beam-irradiated surface 70a of the light emitting part 7, it is possible to emit the laser beams to the laser-beam irradiated surface 70a in such a manner that the laser beams are dispersed two-dimensionally and planarly.

That is, it is only required that a part with the maximum light intensity of a projected image formed when the light emitting part 7 is irradiated with a laser beam from one of the plurality of the exit end parts 5a is positioned differently from a part with the maximum light intensity of another projected image formed when the light emitting part 7 is irradiated with a laser beam from another one of the plurality of the exit end parts 5a. Accordingly, it is not necessarily required to completely separate irradiated regions from each other.

The plurality of exit end parts 5a can be in contact with the laser beam-irradiated surface 70a, and can be at a short distance from the laser beam-irradiated surface 70a. In particular, in a case where the plurality of exit end parts 5a are positioned at a distance from the laser beam-irradiated surface 70a, the distance is preferably set such that a laser beam emitted from the exit end part 5a and broadening conically is totally emitted to the laser beam-irradiated surface 70a. For example, in a case where the laser beam-irradiated surface 70a has an ellipse shape, it is preferable to determine a positional relation between the exit end part 5a and the light emitting part 7 such that the diameter of the conically broadened laser beam does not exceed the short axis of the ellipse.

The optical fiber 5 has a double-layered structure, which consists of (i) a center core and (ii) a clad which surrounds the core and has a refractive index lower than that of the core. The core is made mainly of fused quartz (silicon oxide), which absorbs little laser beam and thus prevents a loss of the laser beam. The clad is made mainly of (a) fused quartz having a refractive index lower than that of the core or (b) synthetic resin material. For example, the optical fiber 5 is made of quartz, and has a core of 200 μm in diameter, a clad of 240 μm in diameter, and numerical apertures (NA) of 0.22. Note however that a structure, diameter, and material of the optical fiber 5 are not limited to those described above. The optical fiber 5 can have a rectangular cross-sectioned surface, which is perpendicular to a longitudinal direction of the optical fiber 5.

Since the optical fiber 5 is flexible, it is possible to easily change the positions of the exit end parts 5a with respect to the laser beam-irradiated surface 70a of the light emitting part 7. This enables positioning the exit end parts 5a to be in accordance with the shape of the laser beam-irradiated surface 70a of the light emitting part 7, enabling mildly irradiating the whole areas of the laser beam-irradiated surface 70a of the light emitting part 7 with a laser beam.

Further, since the optical fiber 5 is flexible, it is possible to easily change a relative positional relation between the laser diode 3 and the light emitting part 7. Further, by arranging the length of the optical fiber 5, it is possible to position the laser diode 3 to be away from the light emitting part 7.

Accordingly, it is possible to improve flexibility in design of the headlamp 1. That is, for example, it is possible to provide the laser diodes 3 so that they can be easily cooled and/or replaced. That is, since the positional relation between the entrance end parts 5b and the exit end parts 5a can be easily changed and a positional relation between the laser diode 3 and the light emitting part 7 can be easily changed, it is possible to improve flexibility in design of the headlamp 1.

The light guide can be a member other than the optical fiber, or can be a combination of the optical fiber and another member. The light guide can be any member as long as the light guide has at least one entrance end part, through which the light guide receives laser beams emitted from the laser diodes 3, and a plurality of exit end parts, through which the light guide emits the laser beams received through the at least one entrance end part. For example, the light guide can be configured such that (i) an entrance part including at least one entrance end part and (ii) an exit part including a plurality of exit end parts are made separately from the optical fiber, and the entrance part and the exit part are connected to respective ends of the optical fiber.

FIG. 3 is a view illustrating a positional relation between the exit end parts 5a and the light emitting part 7. As illustrated in FIG. 3, the ferrule 6 holds, in a predetermined pattern, the plurality of exit end pats 5a of the optical fiber 5 with respect to the laser beam-irradiated surface 70a of the light emitting part 7. The ferrule 6 can have holes provided thereon in a predetermined pattern so as to accommodate the exit end parts 5a. Alternatively, the ferrule 6 can be separated into an upper part and a lower part, each of which has on its bonding surface grooves for sandwiching and accommodating the exit end parts 5a.

The ferrule 6 can be fixed to the reflection mirror 8 by a bar-shaped or tubular member etc. that extends from the reflection mirror 8. The ferrule 6 is not particularly limited in material, and is made of for example stainless steel. Note here that, although three exit end parts 5a are provided in FIG. 3, the number of the exit end parts 5a is not limited to three. Further, a plurality of ferrules 6 may be provided with respect to one light emitting part 7.

The light emitting part 7 emits light upon irradiation with a laser beam emitted from the exit end part 5a, and includes fluorescent material films 76a and 76b each including a fluorescent material which emits light upon irradiation with a laser beam (see FIG. 1). Specifically, in the light emitting part 7, a fluorescent material is deposited on (bound to) a conductive member (e.g. metal plate 75) having a predetermined shape to form the fluorescent material films 76a and 76b. Further, the area of the laser beam-irradiated surface 70a is designed to be smaller than 3 mm². The thickness of the light emitting part 7 is designed to be 1 mm or less for example. What shape the light emitting part 7 has, how the light emitting part 7 is produced, and what material the fluorescent material for the fluorescent material films 76a and 76b is made from will be specifically explained later.

That is, the fluorescent material film is a film formed by depositing on the surface of the conductive member a fluorescent material which emits light upon irradiation with excitation light. The shape of the fluorescent material film may be a film-like shape, a layer-like shape, a thin film, a thin layer, a plate-like shape, and a plate for example.

The light emitting part 7 is provided in the vicinity of a first focal point (described later) of the reflection mirror 8, and is fixed to an inside surface (which faces the exit end parts 5a) of the transparent plate 9 so as to face the exit end parts 5a (see FIG. 2). The method for fixing the light emitting part 7 is not limited to this, and may be fixed by a bar-like or tubular member extending from the reflection mirror 8.

FIG. 4 is a cross sectional view illustrating a modification of a method of positioning the light emitting part 7. As illustrated in FIG. 4, the light emitting part 7 can be fixed to an end of a tubular part 15 that extends through a central portion of the reflection mirror 8. In this case, the exit end parts 5a of the optical fiber 5 can be provided inside the tubular part 15. Further, according to this configuration, the transparent plate 9 can be omitted.

The reflection mirror 8 is for example a member whose surface is coated with a metal thin film. The reflection mirror 8 reflects light emitted from the light emitting part 7, in such a way that the light is converged on a focal point of the reflection mirror 8. Since the headlamp 1 is a projector-type headlamp, a cross-sectional surface of the reflection mirror 8 is basically in an elliptical shape. The reflection mirror 8 has a first focal point and a second focal point. The second focal point is closer to an opening of the reflection mirror 8 than the first focal point is. The convex lens 14 (described later) is provided so that its focal point is in the vicinity of the second focal point, and projects light in a front direction, which light is converged by the reflection mirror 8 on the second focal point.

The transparent plate 9 is a transparent resin plate which covers the opening of the reflection mirror 8, and holds the light emitting part 7 thereon. The transparent plate 9 is preferably made of a material that blocks a laser beam from the laser diode 3 but transmits white light generated by the light emitting part 7 converting the laser beam. Almost all the coherent laser beam is converted by the light emitting part 7 into incoherent white light. However, there is a possibility that a part of the laser beam is not converted for some reason. Even in this case, designing the transparent plate 9 to block a laser beam enables preventing the laser beam from leaking to the outside. In a case where such an effect is not expected and a member other than the transparent 9 holds the light emitting part 7, the transparent plate 9 may be omitted.

The housing 10 is part of a body of the headlamp 1, and holds the reflection mirror 8 etc. therein. The optical fiber 5 penetrates the housing 10. The laser diode array 2 is provided outside the housing 10. Note here that the laser diode array 2 generates heat when emitting a laser beam. In this regard, since the laser diode array 2 is provided outside the housing 10, the laser diode array 2 can be efficiently cooled down. Consequently, the light emitting part 7 does not suffer deterioration in its properties or thermal damage etc. due to heat generated from the laser diode array 2. Further, in consideration of a possibility of the laser diodes 3 being in trouble, it is preferable that the laser diodes 3 be provided so that they can be easily replaced. If there is no need to take these points into consideration, the laser diode array 2 can be provided inside the housing 10.

The extension 11 is provided in an anterior portion of a side surface of the reflection mirror 8. The extension 11 hides an inner structure of the headlamp 1 so that the headlamp 1 looks better, and also strengthens connection between the reflection mirror 8 and an automobile body. The extension 11 is, like the reflection mirror 8, a member whose surface is coated with a metal thin film.

The lens 12 is provided on the opening of the housing 10, and seals the headlamp 1. The light emitted from the light emitting part 7 (light emitted from the light emitting part 7 and reflected by the reflection mirror 8) travels in a front direction from the headlamp 1 through the lens 12.

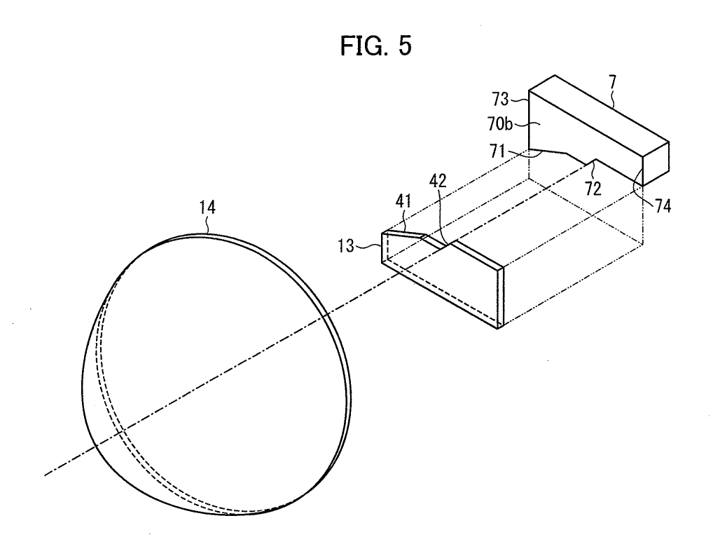

FIG. 5 is a perspective view illustrating a positional relation among the convex lens 14, the light shielding plate 13, and the light emitting part 7. The convex lens 14 converges the light emitted from the light emitting part 7, and projects the converged light in the front direction from the headlamp 1. The convex lens 14 has its focal point in the vicinity of the second focal point of the reflection mirror 8, and its light axis in a substantially central portion of a light emitting surface 70b of the light emitting part 7. The convex lens 14 is held by the lens holder 16, and is specified for its relative position with respect to the reflection mirror 8.

The light shielding plate 13 blocks a part of light emitted from the light emitting part 7 and a part of light reflected by the reflection mirror 8, thereby limiting a region which the light arrives. In other words, the light shielding plate 13 defines a partial shape of a projected image of light emitted from the light emitting part 7. The light shielding plate 13 is positioned in the vicinity of the second focal point of the reflection mirror 8.

The following explains the reasons why the light shielding plate 13 is provided. As explained later, the light emitting part 7 has a shape which enables the light emitting part 7 to efficiently illuminate a bright region defined by the light distribution property standard. If the size of the light emitting part 7 were infinitely small and the light emitting part 7 were positioned only on a light axis of the convex lens 14, a projected image of light emitted from the light emitting surface 70b of the light emitting part 7 would be equal to the shape of the light emitting surface 70b. However, in reality, the light emitting part 7 has dimensions, so that the projected image of the light emitted from the light emitting part 7 blurs in an area at a distance from the light axis of the convex lens 14. Consequently, there is a possibility that a part of the light emitted from the light emitting part 7 is emitted to a region other than the bright region. Further, there is a possibility that a part of reflective light caused when the light from the light emitting part 7 is reflected by the reflection mirror 8 is emitted to a region other than the bright region regardless of the shape of the light emitting part 7. For these reasons, it is preferable to provide the light shielding plate 13. The positional relation between the light shielding plate 13 and the light emitting part 7 will be detailed later.

As described above, high power laser beams from the laser diodes 3 are emitted to the light emitting part 7 and the light emitting part 7 receives these laser beams, so that the headlamp 1 can achieve high luminous flux (luminous flux from the light emitting part 7 is at least 1,200 lm (lumen)) and high luminance (luminance of the light emitting part 7 is at least 80 cd (candela)). Since the headlamp 1 achieves high luminance, the headlamp 1 can be small.

### (Light Distribution Property Required for Headlamp 1)

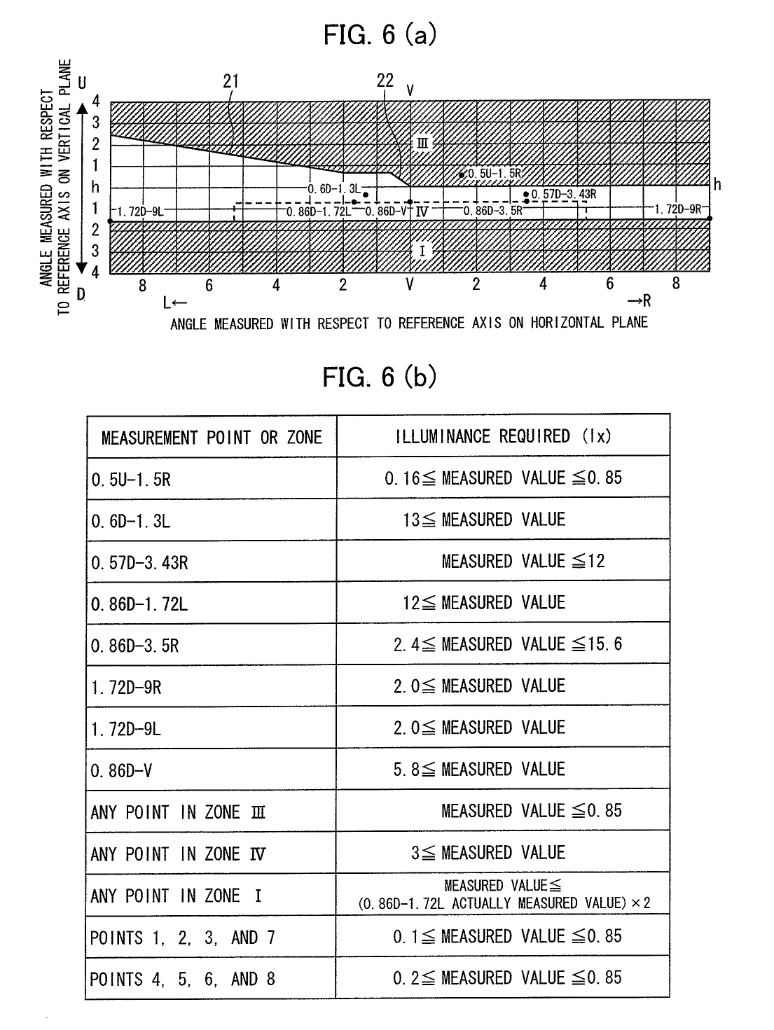

Next, the following description discusses, with reference to FIG. 6, the light distribution property required for the passing headlamp for an automobile.

(a) of FIG. 6 is a view illustrating the light distribution property required for the passing headlamp for an automobile (extracted from Public Notice Specifying Details of Safety Standards for Road Vehicle [Oct. 15, 2008] Appendix 51 (Specified Standards for Style of Headlamp). (a) of FIG. 6 illustrates an image of light projected to a screen, which is provided vertically and 25 m ahead of an automobile. Note here that the light is emitted from the passing headlamp.

In (a) of FIG. 6, a region below a horizontal straight line, which is 750 mm below a straight line hh serving as a horizontal reference straight line, is referred to as Zone I. At any point in Zone I, an illuminance should be two times or more lower than an actual illuminance measured at the point 0.86 D-1.72 L.

A region above an unfilled region (which is referred to as a bright region) is referred to as Zone III. At any point in Zone III, an illuminance should be 0.85 lx (lux) or lower. That is, Zone III is a region in which the illuminance of a beam should be equal to or lower than a certain level (such a region is referred to as a dark region) for the purpose of preventing the beam from interrupting other traffic. A borderline between Zone III and the bright region includes a straight line 21, which is at an angle of 15 degrees with the straight line hh, and a straight line 22, which is at an angle of 45 degrees with the straight line hh.

A region defined by four straight lines, i.e., a region defined by (i) a horizontal straight line 375 mm below the straight line hh, (ii) the horizontal straight line 750 mm below the straight line hh, (iii) a vertical straight line provided on a left side at a distance of 2250 mm from a straight line VV serving as a vertical reference straight line and (iv) a vertical straight line provided on a right side at a distance of 2250 mm from the straight line VV, is referred to as Zone IV. At any point in Zone IV, an illuminance should be higher than or equal to 3 lx. That is, Zone IV is the brightest region in the bright region, which is between Zone I and Zone III.

(b) of FIG. 6 is a table showing an illuminance specified by the light distribution property standards for the passing headlamp. As illustrated in (b) of FIG. 6, at the point 0.6 D-1.3 L and the point 0.86 D-1.72 L, an illuminance should be higher than other surrounding regions. These points are in direct front of the automobile. Therefore, at these points, the illuminance should be high enough for a driver etc. to recognize obstacles etc. present ahead, even at night.

### (Shape of Light Emitting Part 7)

The following specifically explains the shape of the light emitting part 7 with reference to FIG. 1. FIG. 1 is a perspective view illustrating the shape of the light emitting part 7.

The light emitting part 7 consists of (i) the metal plate 75 having a predetermined shape (i.e. shape which meets the light distribution property standard (predetermined light distribution property) and (ii) the fluorescent material films 76a and 76b each obtained by depositing on the metal plate 75 a fluorescent material which emits light upon irradiation with a laser beam. As illustrated in FIG. 1, the metal plate 75 has a notched shape such that a part of a rectangular metal plate is notched. On both surfaces (first surface and second surface) of the metal plate 75, a fluorescent material is deposited by later mentioned electrophoresis (electrophoresis deposition) to form the fluorescent material films 76a and 76b. That is, on the surfaces of the metal plate 75, the fluorescent material films 76a and 76b having substantially the same notched shape as the metal plate 75 are formed, so that the light emitting part 7 having a partially notched rectangular shape is provided.

The laser beam-irradiated surface 70a does not necessarily have to be a flat surface, and can be a curved surface. Note however that, in order to control reflection of a laser beam, it is preferable that the laser beam-irradiated surface 70a be a flat surface perpendicular to a light axis of the laser beam.

The light emitting part 7 has a light emitting surface 70b (see FIG. 5) which is positioned oppositely to the laser beam-irradiated surface 70a. A part of a periphery of the light emitting surface 70b has a notched shape which corresponds to the shape of the dark region (Zone III) illustrated in (a) of FIG. 6.

To be more specific, as illustrated in FIGS. 1 and 5, an outer periphery of the light emitting surface 70b has an oblique line 71 which forms an angle of 15° with respect to its long axis, and has an oblique line 72 which forms an angle of 45° with respect to its long axis. The oblique line 71 corresponds to the line 21 illustrated in (a) of FIG. 6, and the oblique line 72 corresponds to the line 22 illustrated in (a) of FIG. 6. As described above, the outer periphery of the light emitting surface 70b has the oblique lines 71 and 72 corresponding to the shape of the dark region, and the oblique lines 71 and 72 form different angles with respect to a long axis direction of the light emitting surface 70b.

Expressed in terms of other viewpoint, as illustrated in FIG. 5, the light emitting surface 70b has a first end portion 73 in its long axis direction and a second end portion 74 positioned oppositely to the first end portion 73 in its long axis direction. The length of the first end portion 73 in a short axis direction perpendicular to the long axis direction is longer than the length of the second end portion 74 in the short axis direction.

Designing the light emitting surface 70b as above enables emitting luminous flux whose shape corresponds to the shape of the bright region defined by the light distribution property standard. In other words, such designing enables preventing luminous flux emitted from the light emitting part 7 from being directed to the dark region. Therefore, it is possible to increase a utilization ratio of light compared with a conventional art.

### (How to Produce Light Emitting Part 7)

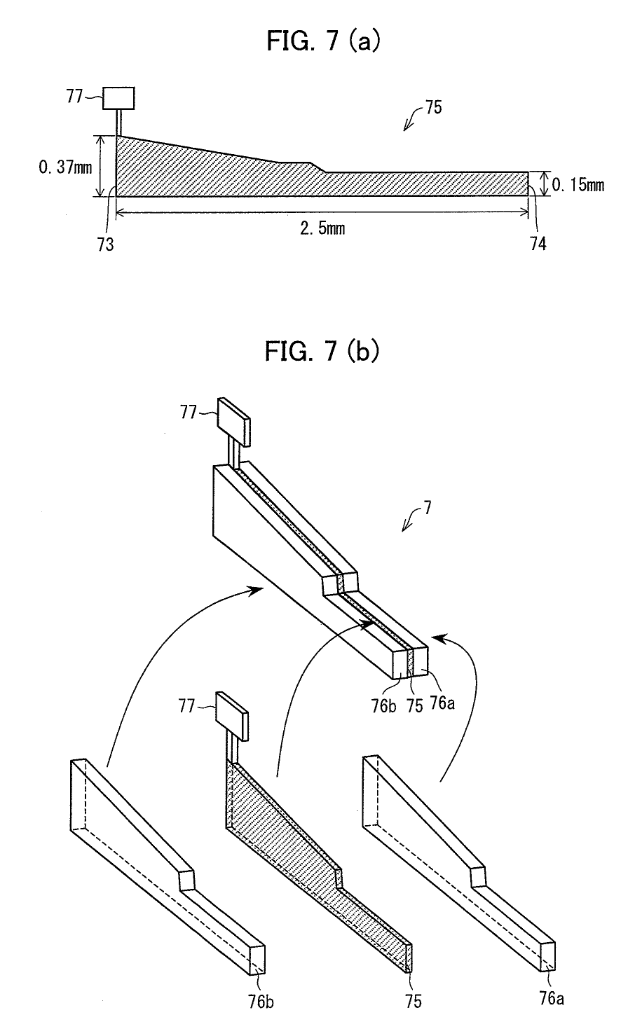

The following explains how to produce the light emitting part 7 with reference to FIGS. 7-9. FIG. 7 is a view explaining a configuration of the light emitting part 7. (a) of FIG. 7 illustrates a cross section of the metal plate 75, and (b) of FIG. 7 explains how to produce the light emitting part 7.

Initially, as illustrated in (a) of FIG. 7, the size of the metal plate 75 is such that, for example, the length in its long axis direction is 2.5 mm, the width (length) in a short axis direction of the first end portion 73 is 0.37 mm, the width (length) in a short axis direction of the second end portion 74 is 0.15 mm, and the thickness is 0.05 mm. In the present embodiment, the metal plate 75 is thin, and so when the metal plate 75 is irradiated with high-power laser light, the metal plate 75 transmits the laser light. Consequently, when a side of the metal plate 75 which side is to serve as the light emitting surface 70b is provided with a fluorescent material film (e.g. the fluorescent material film 76b), the fluorescent material film converts a laser beam to incoherent light.

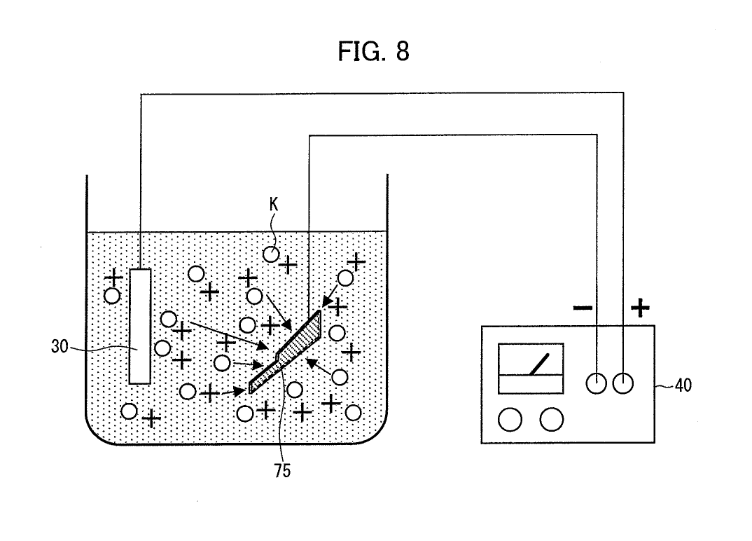

Further, the metal plate 75 has a conducting terminal 77 to be connected with a power source device 40 (see FIG. 8) which is used to deposit a fluorescent material on surfaces of the metal plate 75 by electrophoresis to form the fluorescent material films 76a and 76b. The conducting terminal 77 is coated with an insulating film. An example of the insulating film is a silicon oxide film. Since the conducting terminal 77 is coated with the insulating film, it is possible to prevent the fluorescent material from being deposited on a surface of the conducting terminal 77 by electrophoresis. Consequently, by connecting the conducting terminal 77 having no fluorescent material deposited thereon with the power source device 40, it is possible to easily use the light emitting part 7 as an electrode for electrophoresis.

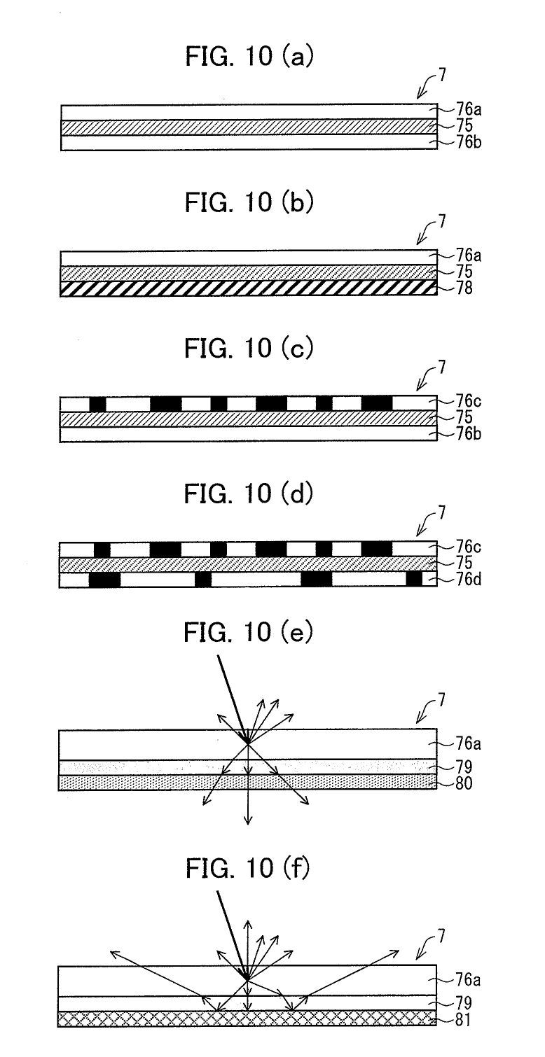

The insulating film is preferably an inorganic material. In a case where a solution for electrophoresis is a one based on an organic solvent, if an organic photoresist etc. is used as an insulating film, there is a possibility that the organic photoresist dissolves in electrophoresis. Of course, in a case where water is used as a solvent, the organic photoresist material may be used as an insulating film. As for use of an inorganic material as an insulating film, the same can be said about an insulating film formed on the metal plate 75 (e.g. insulating layer 78 (insulating film) of (b) of FIG. 10 and insulating films of (c) and (d) of FIG. 10 which will be mentioned later) as well as the insulating film coating the conducting terminal 77.

Each of the fluorescent materials is a kind of oxynitride and/or nitride. The fluorescent materials are blue, green, and red fluorescent materials. Since each of the laser diodes 3 emits a laser beam at a wavelength of 405 nm (bluish purple), the light emitting part 7 emits white light upon irradiation with the laser beam emitted from each of the laser diodes 3. In view of this, the light emitting part 7 can be regarded as being a wavelength conversion material.

Each of the laser diodes 3 can also be a laser diode that emits a laser beam at a wavelength of 450 nm (blue), or a laser diode that emits a laser beam (close to so-called “blue”) which has a peak wavelength falling within a range of not less than 440 nm but not more than 490 nm. In this case, the fluorescent materials should consist of yellow fluorescent materials, or of green and red fluorescent materials. Note here that the yellow fluorescent materials are fluorescent materials each of which emits light having a peak wavelength falling within a range of not less than 560 nm but not more than 590 nm. The green fluorescent materials are fluorescent materials each of which emits light having a peak wavelength falling within a range of not less than 510 nm but not more than 560 nm. The red fluorescent materials are fluorescent materials each of which emits light having a peak wavelength falling within a range of not less than 600 nm but not more than 680 nm.

Each of the fluorescent materials is preferably an oxynitride fluorescent material commonly referred to as a sialon fluorescent material or a nitride fluorescent material. Note here that sialon is silicon nitride in which (i) one or more of silicon atoms are substituted by an aluminum atom(s) and (ii) one or more of nitrogen atoms are substituted by an oxygen atom(s). The sialon fluorescent material can be produced by solidifying alumina (Al₂O₃), silica (SiO₂), a rare-earth element, and/or the like with silicon nitride (Si₃N₄).

Another preferable example of the fluorescent materials is a semiconductor nanoparticle fluorescent material, which includes nanometer-size particles of a III-V group compound semiconductor.

One characteristic of the semiconductor nanoparticle fluorescent material is that, for example, even if the nanoparticles are made of an identical compound semiconductor (e.g., indium phosphorus: InP), it is possible to cause the nanoparticles to emit light of different colors by changing particle size of the nanoparticles. The change in color occurs due to a quantum size effect. For example, in the case where the semiconductor nanoparticle fluorescent material is made of InP, the semiconductor nanoparticle fluorescent material emits red light when each of the nanoparticles is approximately 3 nm to 4 nm in particle size (note here that the particle size is evaluated with use of a transmission electron microscope [TEM]).

Further, the semiconductor nanoparticle fluorescent material is a semiconductor-based material, and therefore the life of the fluorescence is short. Accordingly, the semiconductor nanoparticle fluorescent material can quickly convert power of the excitation light into fluorescence, and therefore is highly resistant to high-power excitation light. This is because the emission life of the semiconductor nanoparticle fluorescent material is approximately 10 nanoseconds, which is some five digits less than a commonly used fluorescent material that contains rare earth as a luminescence center.

In addition, since the emission life is short as described above, it is possible to quickly repeat absorption of a laser beam and emission of fluorescence. As such, it is possible to maintain high efficiency with respect to intense laser beams, thereby reducing heat emission from the fluorescent materials.

This makes it possible to further prevent a heat deterioration (discoloration and/or deformation) in the light emitting part 7. As such, it is possible to further prevent a reduction in the life of the light emitting device which employs a high-power light emitting element as a light source.

As illustrated in (b) of FIG. 7, in production of the light emitting part 7, fluorescent materials are deposited on (bound to), by electrophoresis, surfaces of the metal plate 75 designed to have a shape meeting the light distribution property standard (miniature shape of a light distribution pattern required for a passing headlamp of an automobile), thereby forming the fluorescent material films 76a and 76b. In this process, the fluorescent material is not deposited on the surface of the conducting terminal 77 since the conducting terminal 77 is coated with an insulating film. After the fluorescent material films 76a and 76b are formed, the conducting terminal 77 is cut, so that the light emitting part 7 having the shape illustrated in FIG. 1 is produced.

With reference to FIG. 8, the following explains an example of a test system in which a fluorescent material is deposited by electrophoresis on surfaces of the metal plate 75 to form the fluorescent material films 76a and 76b. FIG. 8 is a view explaining an example of a test system in which a fluorescent material is deposited by electrophoresis on surfaces of the metal plate 75 to form the fluorescent material films 76a and 76b.

A solution in a vessel (beaker) illustrated in FIG. 8 is obtained by dispersing BaMgAl₁₀O₁₇: Eu²⁺ (blue), β-SiAlON: Eu²⁺ (green), and CASN: Eu²⁺ (red) in a dispersion solvent in such a manner that a dispersion ratio (weight ratio) is 4:2:1, respectively. That is, the fluorescent materials are disposed as charged particles K in a dispersion solvent. Examples of the dispersion solvent include electrolytic or non-electrolytic ketones (e.g. acetone, methylethylketone), alcohols (e.g. methanol, ethanol, and isopropanol), alcohol ethers (e.g. 2-methoxyethanol), organic solvents which are mixtures thereof, and water.

As electrodes for electrophoresis, two metal plates (one of which is the metal plate 75) are immersed in this solution (dispersion solvent in which positively-ionized fluorescent materials (charged particles K) are dispersed), and the metal plate 75 serves as a cathode and a metal plate 30 which is the other metal plate serves as an anode. That is, the conducting terminal 77 of the metal plate 75 is connected with a negative electrode of the power source device 40 and the metal plate 30 is connected with a positive electrode of the power source device 40. The power source device 40 is a voltage power source for a direct current, and applies a predetermined voltage across two electrodes to flow an electric current, thereby moving the positively-ionized fluorescent materials to the metal plate 75 serving as a cathode (electrophoresis).

That is, the positively-ionized fluorescent materials are moved to the surfaces of the negatively charged metal plate 75, so that the fluorescent materials are deposited on the surfaces and the fluorescent material films 76a and 76b are formed. In the case of deposition by electrophoresis, the fluorescent materials are deposited on the whole surfaces of the metal plate 75 or on ranges which are a little narrower than the whole surfaces of the metal plate 75 evenly, thinly, and with substantially a predetermined thickness, so that the fluorescent material films 76a and 76b are formed. Thus, the fluorescent material films 76a and 76b having substantially the same shape as the metal plate 75 and having a predetermined thickness are formed on the metal plate 75. Accordingly, merely by designing the metal plate 75 to have a desired shape and carrying out electrophoresis in a solution in which fluorescent materials are dispersed, it is possible to easily produce the light emitting part 7 having a surface whose shape is substantially the same as that of the surface of the metal plate 75.

In the present embodiment, the fluorescent material films 76a and 76b are designed to have a thickness of 0.5 mm. Further, since the surface area of the metal plate 75 is smaller than 3 mm², the laser beam-irradiated surface 70a of the light emitting part 7 is also designed to have an area of smaller than 3 mm².

By carrying out electrophoresis, the fluorescent material films 76a and 76b are formed on the surfaces of the metal plate 75. The fluorescent material films 76a and 76b are fixed to (bound to) the metal plate 75 in the following manner.

Initially, ethanol, water, and concentrated hydrochloric acid are added to TEOS (tetraethoxysilane) or TEMOS (tetramethoxysilane) to form a precursor of silica (silica precursor). Then, the silica precursor is dispersed on and immersed in the fluorescent material films 76a and 76b, and the fluorescent material films 76a and 76b are sintered at approximately 500° C. Thus, the fluorescent material films 76a and 76b are fixed to the metal plate 75.

It should be noted that although Patent Literatures 4 and 5 disclose application of a fluorescent material film onto a substrate, Patent Literatures 4 and 5 do not disclose the aforementioned process of producing the light emitting part (process of forming a fluorescent material film) at all.

In a case where the light emitting part is used as a vehicle headlamp, the light emitting part may emit any illumination light as long as the illumination light has a color temperature of 3,000-7,000K and is white light which falls within a range of a white color required for a headlamp defined in the Road Transport Vehicle Act. The color temperature may be adjusted to be a one favored by many users in the market.

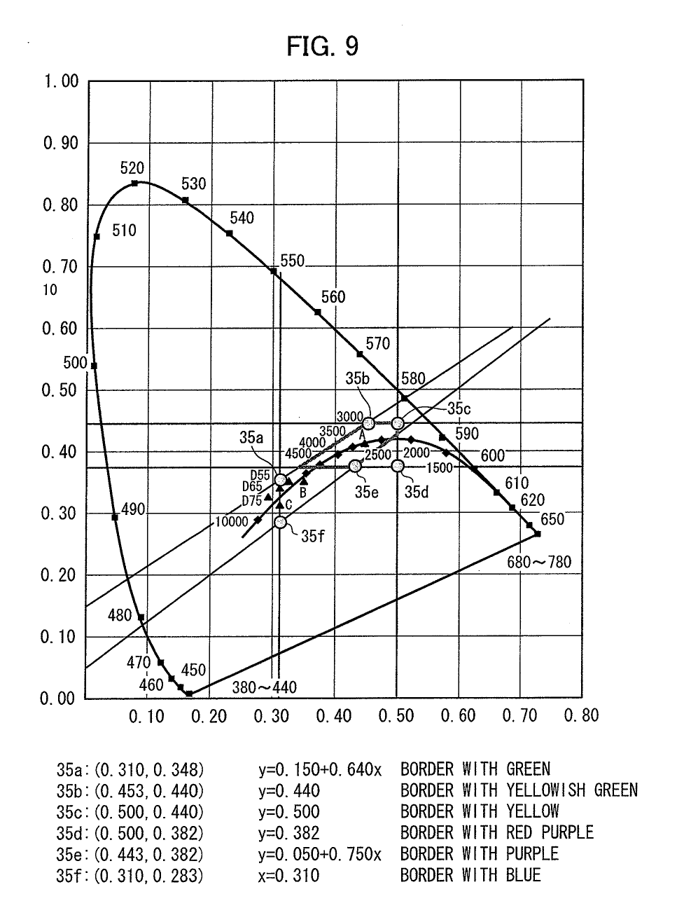

FIG. 9 is a graph showing a chromaticity range of a white color required for a headlamp. As illustrated in FIG. 9, the chromaticity range of a white color required for a headlamp is defined by the law. The chromaticity range exists within a polygon with six points of 35a-35f. When excitation light at 405 nm was emitted to the light emitting part 7 produced in the test system illustrated in FIG. 8, the light emitting part 7 emitted light which falls within the chromaticity range, i.e. white light with chromaticity x=0.31 and y=0.30.

One possible option for designing the light emitting part 7 as above is to scrape a rectangular parallelepiped to have a notched part shaped to meet the light distribution property standard. Formation of the notched part is made by physically or chemically scraping a rectangular parallelepiped having fluorescent materials dispersed inside silicone resin serving as a fluorescent material holding substance. However, since the fluorescent material is particulate, when the silicone resin is scraped, the fluorescent material inside the silicone resin is also scraped and damaged. This raises a problem of reduction in a luminous efficiency of a fluorescent material close to a surface of the silicone resin. In contrast thereto, the metal plate 75 is easy to form (without any concern for the scraped fluorescent material), and particularly in the case of deposition by electrophoresis, the fluorescent material films 76a and 76b can be formed on the surfaces of the metal plate 75 in such a manner that the fluorescent material films 76a and 76b are shaped to correspond to the shape of the metal plate 75. For this reason, when it is required to minutely and accurately produce the light emitting part 7, it is desirable to deposit, by electrophoresis, fluorescent materials on the metal plate 75 with a desired shape to form the fluorescent material films 76a and 76b.

As described above, the light emitting part 7 is obtained by depositing, on the metal plate 75 with a predetermined shape, fluorescent materials which emit light upon irradiation with a laser beam to form the fluorescent material films 76a and 76b.

Designing the metal plate 75 to have a shape corresponding to a shape meeting a predetermined light distribution property can be made easily by a conventional method even if the metal plate 75 is required to be small and have a complicated shape. Since the light emitting part 7 can be produced only by depositing fluorescent materials on the easily shapable metal plate 75 to form the fluorescent material films 76a and 76b, the light emitting part 7 with a desired shape (e.g. complicated shape) can be easily realized even if the light emitting part 7 is required to be small. Accordingly, the light emitting part 7 can realize a high utilization ratio of light. Accordingly, the headlamp 1 including the light emitting part 7 can increase a utilization ratio of light.

In conventional production of a light emitting part with use of a mold, it is necessary to pour resin having fluorescent materials therein into the mold, and so it is necessary to prepare a mold with a predetermined thickness. Consequently, in order to produce a very thin (e.g. approximately 1 mm in thickness) light emitting part, it is necessary to carry out a thinning process such as polishing after pouring the resin into the mold. In contrast thereto, the light emitting part 7 in accordance with the present embodiment can be produced by thinly depositing the fluorescent materials on the thin (0.05 mm in thickness in the present embodiment) metal plate 75 to form the fluorescent material films 76a and 76b, and therefore it is possible to easily produce the thin (0.5 mm in thickness in the present embodiment) light emitting part 7 without the thinning process. That is, in the present embodiment, it is possible to easily produce the light emitting part 7 such that the light emitting part 7 is small and thin and has a predetermined shape.

Further, since the metal plate 75 is a plate, the metal plate 75 can be easily processed to have a desired shape (predetermined shape). Further, by immersing the metal plate 75 in a dispersion solvent containing fluorescent materials in such a manner that the metal plate 75 serves as an electrode, it is possible to deposit the fluorescent materials on the surfaces of the metal plate 75 to form the fluorescent material films 76a and 76b. Therefore, merely by immersing the easily shapable metal plate 75 in the dispersion solvent containing the fluorescent materials, it is possible to easily achieve the light emitting part 7 with a predetermined shape.

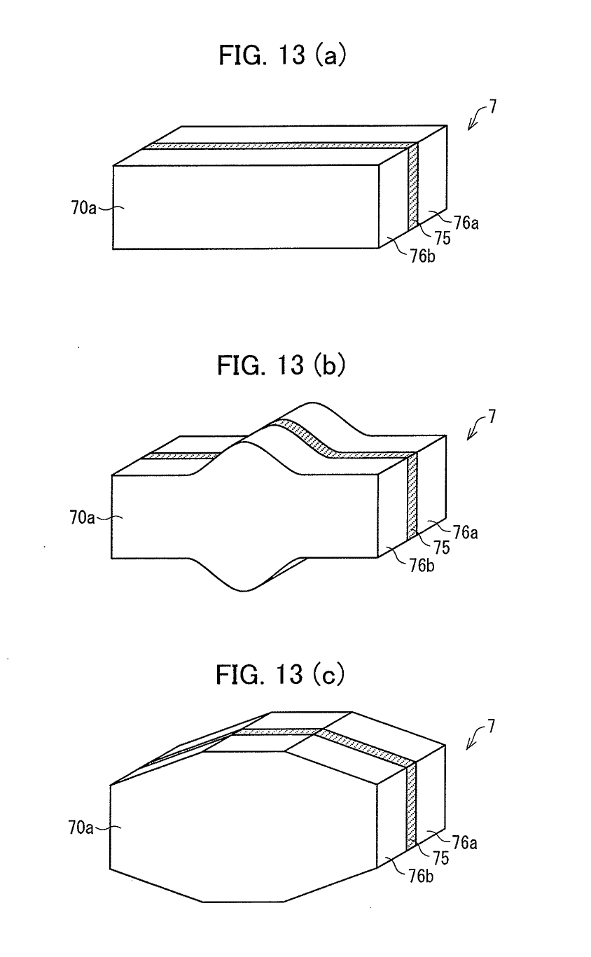

With reference to FIG. 10, the following explains an example of a configuration or a material of the light emitting part 7 which is produced by electrophoresis. FIG. 10 is a view explaining an example of a configuration or a material of the light emitting part 7, and showing a cross section of the light emitting part 7. (a) of FIG. 10 illustrates a cross section of the light emitting part 7 illustrated in FIG. 1 produced by the above process and (b)-(f) of FIG. 10 illustrate cross sections of modification examples of the light emitting part 7 illustrated in FIG. 1. Herein, an explanation will be made on the premise that the light emitting part 7 has a shape meeting the light distribution property standard. However, the shape of the light emitting part 7 may be any shape (e.g. shapes illustrated in later-mentioned (a)-(c) of FIG. 13) as long as the light emitting part 7 meets a predetermined light distribution property required for an illuminating device such as the headlamp 1.

(a) of FIG. 10 is a cross sectional drawing of the light emitting part 7 illustrated in FIG. 1. As described above, the light emitting part 7 is obtained by evenly depositing the fluorescent materials on the whole of both sides (equal to surfaces) of the metal plate 75 to form the fluorescent material films 76a and 76b.

Since the fluorescent materials are deposited as above, it is unnecessary to mold the light emitting part 7 itself. Accordingly, even if the light emitting part 7 is required to have a complicated shape, it is possible to easily produce the light emitting part 7. Further, since the fluorescent material films 76a and 76b are formed on respective sides of the metal plate 75, the light emitting part 7 is applicable to, for example, a light emitting device which emits a laser beam to both of the fluorescent material films 76a and 76b.

(b) of FIG. 10 shows a case where the metal plate 75 is shaped, and then an insulating layer 78 (insulating film) is formed on one side of the metal plate 75 and the metal plate 75 is immersed as an electrode serving as cathode in the solution and electrophoresis is carried out. The insulating layer 78 is made of the same material as the aforementioned insulating film for example, and is formed by being evaporated on the metal plate 75. In this case, fluorescent materials are not deposited on the surface of the metal plate 75 on which surface the insulating layer 78 is formed, and consequently the fluorescent materials are deposited on only one side of the metal plate 75 to form the fluorescent material film 76a. In other words, In (b) of FIG. 10, the fluorescent material film 76a is formed on a laser beam-irradiated surface 70a of the metal plate 75 which surface is irradiated with a laser beam, and the insulating layer 78 is formed on a surface (light emitting surface 70b) positioned oppositely to the laser beam-irradiated surface 70a.

By depositing the fluorescent materials in this manner, it is possible to form a fluorescent material film only on a surface of the metal plate 75 which surface serves as the laser beam-irradiated surface 70a. That is, it is possible to achieve the light emitting part 7 in which the fluorescent material film 76a is formed only on one side of the metal plate 75.

(c) of FIG. 10 shows a case where the metal plate 75 is shaped and then an insulating film with a predetermined pattern is formed on one side of the metal plate 75. For example, an insulating film is evaporated on one side of the metal plate 75 and then resistor is applied on the surface of the insulating film. A pattern mask with a predetermined pattern is attached to the surface of the metal plate 75 to which the resistor has been applied, and the metal plate 75 is irradiated with UV ray to deform a region which is not coated with the pattern mask, and then the metal plate 75 is immersed in a developing solution. Thus, the predetermined pattern is formed on the insulating film.

The insulating film having the predetermined pattern thereon is subjected to etching (e.g. anisotropic etching) and the metal plate 75 having the etched insulating film is immersed as an electrode for cathode in the solution and electrophoresis is carried out. Thus, the fluorescent materials are deposited on the etched region and a fluorescent material film 76c is formed. In other words, in (c) of FIG. 10, the fluorescent material film 76c is formed by depositing fluorescent materials on a region other than the insulating film with the predetermined pattern coating the surface of the metal plate 75. In (c) of FIG. 10, the dark part of the fluorescent material film 76c indicates the insulating film and the bright part of the fluorescent material film 76c indicates the deposited fluorescent materials.

By depositing the fluorescent materials in this manner, it is possible to deposit the fluorescent materials on a region to be strongly irradiated with a laser beam when, for example, the surface of the fluorescent material film 76c is used as the laser beam-irradiated surface 70a. Further, even if it is impossible to realize a desired minute shape by shaping the metal plate 75, it is possible to realize the minute shape by shaping the fluorescent material film in such a manner that an insulating film with a predetermined pattern is formed on the surface of the metal plate 75. That is, it is possible to increase flexibility in design of the light emitting part 7.

In (c) of FIG. 10, for example, in a case where an insulating film on which fluorescent materials can be deposited is evaporated on the fluorescent material film 76c (e.g. in a case where the dispersion solvent contains a binding agent which enables the fluorescent materials to be bound to the insulating film), it is possible to deposit the fluorescent materials on the insulating film. In this case, the fluorescent materials deposited on a region other than the insulating film are thicker than the fluorescent materials deposited on the insulating film. Accordingly, it is possible to thicken the fluorescent materials deposited on, for example, a region of the laser beam-irradiated surface 70a which region is to be strongly irradiated with a laser beam. Therefore, also in this case, it is possible to improve flexibility in design of the light emitting part 7.

Further, even in a case where the metal plate 75 has a rectangular shape (i.e. shape which does not meet the light distribution property standard), by forming a fluorescent material film having a shape meeting the light distribution property standard like the fluorescent material film 76c illustrated in (C) of FIG. 10, it is possible to produce the light emitting part 7 having a function similar to that of the light emitting part 7 of the embodiment illustrated in FIG. 1. Therefore, by shaping the fluorescent material film 76c to meet the light distribution property standard, it is possible to increase a utilization ratio of light.

(d) of FIG. 10 shows a case where, by a process similar to that in (c) of FIG. 10, the light emitting part 7 is designed such that fluorescent material films having insulating films with predetermined patterns that differ from each other are formed on respective sides of the metal plate 75. In other words, in (d) of FIG. 10, fluorescent material films 76c and 76d are formed on respective sides of the metal plate 75. When one of the respective sides of the metal plate 75 is referred to as a first surface and the other is referred to as a second surface, the first surface and the second surface are coated with insulating films with predetermined patterns that differ from each other. In (d) of FIG. 10, for example, a surface of the metal plate 75 on which surface the fluorescent material film 76c is formed is referred to as the first surface and a surface of the metal plate 75 on which surface the fluorescent material film 76d is formed is referred to as the second surface.

By depositing the fluorescent materials in this manner, it is possible to further increase a utilization ratio of light in the light emitting part 7 and improve flexibility in design of the light emitting part 7, compared with a case where a fluorescent material film having an insulating film with a predetermined pattern is formed only on one side of the metal plate 75 (i.e. case of (c) of FIG. 10). Thus, the light emitting part 7 of this embodiment is applicable more broadly.

(e) and (f) of FIG. 10 show cases where the light emitting part 7 is designed to replace the metal plate 75 with a transparent conductive film (conductive member). An example of the transparent conductive film is ITO (Indium Tin Oxide).

In the case illustrated in (e) of FIG. 10, an ITO 79 is evaporated on a transparent substrate 80 such as quartz. The substrate 80 on which the ITO 79 has been evaporated is immersed as an electrode for cathode in the aforementioned solution and electrophoresis is carried out. In this case, since the substrate 80 is made of the same material as that of an insulating film, fluorescent materials are not deposited on a surface of the substrate 80 on which surface the ITO 79 is not evaporated.

Even when the ITO 79 is used instead of the metal plate 75, it is possible to deposit and form the fluorescent materials on the surface of the ITO 79 to form a fluorescent material film as above. That is, it is possible to achieve the light emitting part 7 in which the fluorescent material film 76a is formed only on one side of the ITO 79.

The ITO 79 is a transparent member. If the substrate 80 is also transparent, it is possible to surely cause the light emitting surface 70b to emit incoherent light converted from a laser beam. It should be noted that the similar effect can be obtained when the conductive member is a transparent member other than the ITO 79.

In the case of (f) of FIG. 10, a reflecting layer (light reflecting member) 81 made of a metal film for example is used instead of the substrate 80. The reflecting layer 81 on which the ITO 79 has been evaporated is immersed as an electrode for cathode in the aforementioned solution and electrophoresis is carried out. In this case, it is desirable that the reflecting layer 81 is made of a material on which a fluorescent material cannot be deposited (e.g. aluminum-evaporated film whose surface is coated with resin for preventing scars and oxidization).

That is, in the case of (f) of FIG. 10, a fluorescent material film 76a is formed on a laser beam-irradiated surface 70a which is to be irradiated with a laser beam, and the reflecting layer 81 for reflecting light emitted from the fluorescent material film 76a is formed on a surface positioned oppositely to the laser beam-irradiated surface 70a. As described above, in the case where the ITO 79 is formed on the reflecting layer 81, it is possible to emit incoherent light transmitted by the ITO 79 to the laser beam-irradiated surface 70a (it is possible to converge the light in a predetermined direction), so that it is possible to surely emit the light to the reflection mirror 8. Further, even if a laser beam which has not been converted by the fluorescent material film 76a is emitted to the ITO 79, the laser beam is reflected by the reflecting layer 81 and is emitted to the fluorescent material film 76a again, so that the laser beam is surely converted into incoherent light. Accordingly, the laser beam emitted form the laser diodes 3 is not emitted from the light emitting part 7, so that it is possible to achieve the highly safe light emitting part 7. It should be noted that the embodiment illustrated in (f) of FIG. 10 yields the same effect when the metal plate 75 is used instead of the ITO 79.

### (Regarding Heat Release)

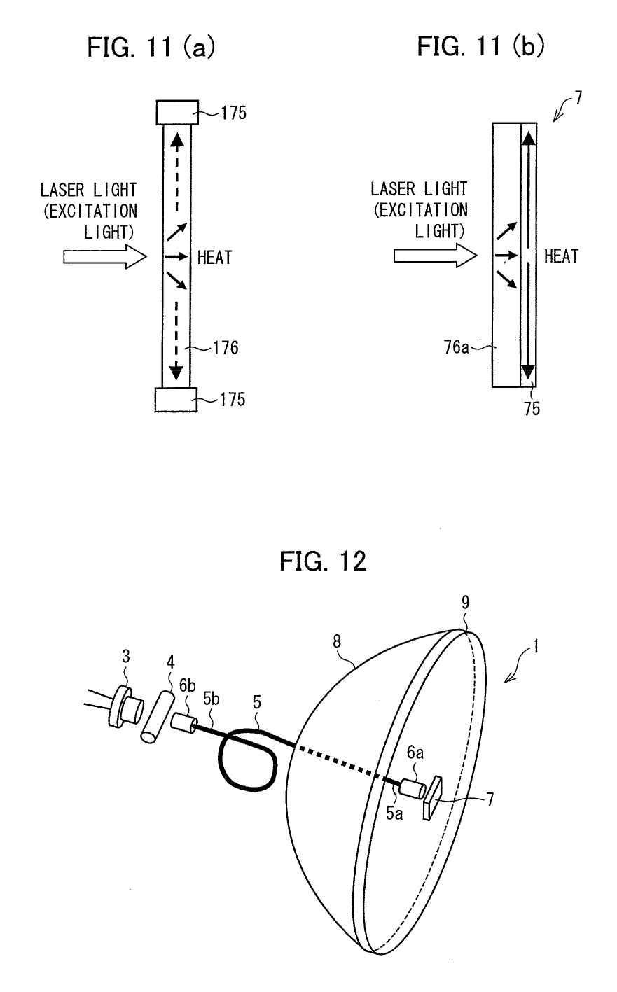

The following explains heat release of the light emitting part 7 with reference to FIG. 11. FIG. 11 is a view explaining release of heat from the light emitting part 7. (a) of FIG. 11 illustrates how heat is propagated in a light emitting part serving as a Comparative Example. (b) of FIG. 11 illustrates how heat is propagated in the light emitting part 7.

When a minute light emitting part containing fluorescent materials is excited by a high-power laser beam (i.e. excited by high-power density) as in the present embodiment, there arises a problem of great deterioration of the light emitting part. This problem was found by the inventor of the present invention and the inventor's colleagues for the first time, and no publicly known documents have clearly mentioned this problem as long as the inventor and the colleagues know.

One possible option for preventing deterioration of the light emitting part is to reduce intensity (unit: watt) of a laser beam emitted to the light emitting part. However, there is a possibility that this option reduces the amount of light (luminous flux) emitted from the light emitting part and is unable to achieve intensity of light required for a light emitting device.

One possible option for preventing deterioration of the light emitting part without reducing intensity of a laser beam is to release, from the light emitting part, heat generated in the light emitting part due to irradiation with a laser beam.

In this case, as shown in the Comparative Example illustrated in (a) of FIG. 11, the outer periphery of the light emitting part is coated with a metal member 175 (metal member for releasing heat) in order to release from the light emitting part heat generated in the light emitting part due to irradiation with a laser beam. This utilizes a nature of a metal to propagate (release) heat.

However, in this case, emission of light to an area coated with the metal member 175 is blocked (shielded), so that a utilization ratio of light drops. Further, since the metal member 175 is provided at the outer periphery of the light emitting part, there is a distance between a region irradiated with a laser beam and the metal member 175. This results in insufficient heat release. That is, in the Comparative Example, heat generated in the vicinity of the region irradiated with a laser beam is propagated in a fluorescent material film having lower heat conductivity than the metal member 175, so that the fluorescent material film is likely to be filled with heat. This is likely to result in deterioration of the light emitting part.

In contrast thereto, in the present embodiment, as illustrated in (b) of FIG. 11, the fluorescent material film 76a is formed on the surface of the metal plate 75 by electrophoresis. That is, the metal plate 75 (metal member for heat release) is formed in the vicinity of a region irradiated with a laser beam. Accordingly, even if a large amount of heat is generated at the region irradiated with a laser beam or a region in the vicinity of the region irradiated with a laser beam, the heat is quickly diffused (efficiently released) since the metal plate 75 is positioned in the vicinity of the fluorescent material film 76a. This prevents deterioration of the light emitting part.

Further, by providing the headlamp 1 with the light emitting part 7 of the above embodiment, it is possible to achieve a light emitting device and an illuminating device in each of which a light emitting part deteriorates little. That is, the present embodiment can achieve a light emitting part with a long life, and consequently a light emitting device, an illuminating device, and a vehicle headlamp each with a long life.

In the present embodiment, an explanation has been made to a case where the metal plate 75 is used as a conductive member. Alternatively, a transparent material having a high thermal conductivity, such as gallium nitride, magnesia (MgO), and sapphire may be used instead of the metal plate 75. In a case where these alternative materials are used, a transparent conductive layer is formed on the surfaces of these alternative materials in the manner as described above.

### (Positional Relationship Between Light Emitting Part 7 and Light Shielding Plate 13)

The following explains a positional relationship between the light emitting part 7 and the light shielding plate 13 with reference to FIG. 5. As illustrated in FIG. 5, the light emitting part 7, the light shielding plate 13, and the convex lens 14 are positioned in this order, and the light emitting surface 70b of the light emitting part 7 faces the convex lens 14. Light emitted from the light emitting surface 70b is partially blocked by the light shielding plate 13 and the rest of the light reaches the convex lens 14. When the light passes through the convex lens 14, an image of the light is turned upside down. Consequently, light having been emitted from the light emitting surface 70b and passed through the convex lens 14 forms a projected image corresponding to the image illustrated in (a) of FIG. 6.

The outer periphery of a surface of the light shielding plate 13 which surface faces the light emitting part 7 has an oblique line 41 corresponding to the oblique line 71 of the light emitting surface 70b and an oblique line 42 corresponding to the oblique line 72 of the light emitting surface 70b. The light emitting surface 70b is positioned to be substantially perpendicular to a light axis of the convex lens 14, and the widest surface of the light shielding plate 13 is positioned to be parallel to the light emitting surface 70b. Further, the light emitting part 7 and the light shielding plate 13 are positioned in such a manner that when seen from a light axis direction of the convex lens 14, the oblique line 71 and the oblique line 41 slightly overlap each other or are adjacent to each other and the oblique line 72 and the oblique line 42 slightly overlap each other or are adjacent to each other.

With this configuration, a part of luminous flux emitted from the light emitting surface 70b is blocked by the light shielding plate 13, so that the shape of a projected image of the luminous flux is more surely close to the shape of the bright region defined by the light distribution property standard.

### (Modification Example of Headlamp 1)

Next, the following description discusses, with reference to FIG. 12, a modification example of the headlamp 1. FIG. 12 is a view schematically illustrating how a headlamp 1, which is a modification example of the present embodiment, is configured. Note here that descriptions for configurations same as those of the earlier-described headlamp 1 are omitted here. The headlamp 1 illustrated in FIG. 12 is designed such that the shape of the reflection mirror 8 is not an ellipse but a circle.

The laser diodes 3 may be provided on a substrate to constitute a laser diode array. Each laser diode 3 includes a chip on which ten luminous points (ten stripes) are provided. For example, the laser diode 3 emits a laser beam at a wavelength of 405 nm (bluish purple), and its output is 11.2 W, operating voltage is 5 V, and operating current is 6.4 A. The laser diode 3 is sealed in a package that is 9 mm in diameter. Note here that only one laser diode 3 (which is sealed in the package) is provided, and power consumption of the laser diode 3 is 32 W when output is 11.2 W.

A rod lens is used as the aspheric lens 4. Further, the aspheric lens 4 is corrected so as to make an aspect ratio of FFP (Far Field Pattern) of a laser beam emitted to the entrance end part 5b of the optical fiber 5 as close to a perfect circle as possible. As used herein, the FFP indicates distribution of luminous intensities in a surface at a distance from a luminous point of a laser source. Generally, a laser beam emitted from an active layer of a semiconductor light emitting element such as the laser diode 3 or of a side surface light emitting-type diode will be dispersed widely due to a diffraction phenomenon, so that the FFP becomes an elliptical shape. Therefore, correction is needed for making the FFP close to a perfect circle.

An entrance end part 5b and an exit end part 5a of an optical fiber 5 have ferrules 6b and 6a, respectively, which serve as supporting members for supporting the optical fiber 5. The functions of the ferrules 6a and 6b are the same as that of the ferrule 6. A laser beam emitted from the laser diode 3 enters the entrance end part 5b of the optical fiber 5 via the aspheric lens 4. The core diameter of the optical fiber 5 is 1 mm, but is not limited to this.

The light emitting part 7 is fixed in such a manner that it (i) is on an inner surface (i.e., a surface facing the exit end part 5a) of the transparent plate 9, (ii) faces the exit end part 5a, and (iii) is at a focal point (or in the vicinity of the focal point) of the reflection mirror 8. A method of fixing a position of the light emitting part 7 is not limited to this, and therefore the light emitting part 7 can be fixed by using a bar-shaped or tubular member extending from the reflection mirror 8, as illustrated in FIG. 4.

The reflection mirror 8 reflects incoherent light (which may be hereinafter referred to merely as “light”) emitted from the light emitting part 7, thereby forming a bundle of beams reflected at predetermined solid angles. That is, the reflection mirror 8 reflects light emitted from the light emitting part 7, thereby forming a bundle of beams traveling in a forward direction from the headlamp 1. The reflection mirror 8 is for example a member having a curved surface (cup shape), whose surface is coated with a metal thin film. The reflection mirror 8 has an opening, which opens toward a direction in which the reflected light travels. The reflection mirror 8 has a hemispheroidal shape, whose center is a focal point of the reflection mirror 8.

As described above, as in the case of the headlamp 1 of the projector type, a high power laser beam from the laser diode 3 is emitted to the light emitting part 7 and the light emitting part 7 receives the laser beam, so that the headlamp 1 can achieve high luminous flux and high luminance. Since the headlamp 1 achieves high luminance, the headlamp 1 can be small.

### (Another Shape of Light Emitting Part 7)

The following explains another shape of the light emitting part 7 with reference to FIG. 13. In the above, explanations were made as to cases where the present invention is applied to a passing headlamp for an automobile. Alternatively, the present invention may be applied to a driving headlamp (high beam) for an automobile. (a)-(c) of FIG. 13 are perspective drawings showing examples of another shape of the light emitting part 7 included in the headlamp 1 in accordance with the present embodiment.

In (a)-(c) of FIG. 13, a metal plate 75 is used as a conductive material and fluorescent material films 76a and 76b are deposited on respective sides of the metal plate 75 to form the light emitting part 7. That is, the light emitting parts 7 illustrated in (a), (b), and (c) of FIG. 13 are obtained in such a manner that the metal plates 75 are shaped to have the shapes illustrated in (a), (b), and (c) of FIG. 13, respectively, and then the respective metal plates 75 are immersed as electrodes for cathodes in the solution illustrated in FIG. 8 and electrophoresis is carried out, so that the fluorescent material films 76a and 76b are deposited on both sides of the respective metal plates 75. As illustrated in (e) and (f) of FIG. 10, fluorescent material films may be formed using an ITO 79 instead of the metal plate 75.

The light emitting part 7 used for a driving headlamp may be shaped to be a rectangular parallelepiped which is longer in a horizontal direction than in a vertical direction as illustrated in (a) of FIG. 13. It is desirable that a light distribution pattern (light distribution) of light emitted from the driving headlamp is narrow in a vertical direction and wide in a horizontal direction. This light distribution pattern enables the driving headlamp to illuminate both a far ahead of a road and sidewalks at both sides of the road. By shaping the light emitting part 7 to be a rectangular parallelepiped which is longer in a horizontal direction than in a vertical direction, it is possible to achieve the light distribution pattern.

In a case where a plurality of exit end parts 5a for emitting a laser beam are provided, the plurality of exit end parts 5a may be positioned evenly with respect to the laser beam-irradiated surface 70a or may be positioned thickly at and around the center in a long axis direction of the laser beam-irradiated surface 70a. With this configuration, the central part (part where the exit end parts 5a are positioned thickly) of the light emitting part 7 emits stronger light than other parts of the light emitting part 7, so that it is possible to increase intensity of illumination of the center part of a region irradiated with light from the headlamp 1 (i.e. the center part of a region positioned ahead of an automobile).

According to the light distribution property standard defined in the Safety Standards for Road Vehicle, intensity of light at a predetermined illumination region is set to be higher than that at other illumination region. In the case where the plurality of exit end parts 5a are provided, the plurality of exit end parts 5a should be positioned to meet the light distribution property standard.

Further, as in the light emitting part 7 illustrated in (b) of FIG. 13, central parts of the laser beam-irradiated surface 70a and the light emitting surface 70b in respective long axis directions are made wider than respective both ends, and the widened parts are also provided with the exit end parts 5a. In other words, the width of the light emitting surface 70b of the light emitting part 7 in a short axis direction thereof is longer at the center part of the light emitting surface 70b in a long axis direction thereof than at the both ends of the light emitting surface 70b in the long axis direction thereof.

Further, in addition to the shape illustrated in (b) of FIG. 13 where the center part of the laser beam-irradiated surface 70a (light emitting surface 70b) bulges, the light emitting part 7 may be shaped in such a manner that the width of the laser beam-irradiated surface 70a gets gradually longer as the width is closer to the center part.

With these configurations, it is possible to increase intensity of illumination at the center part of a region irradiated with light from a headlamp. Accordingly, the headlamp can more property meet the light distribution property standard required for a driving headlamp.

### (Structure of Laser Diode 3)

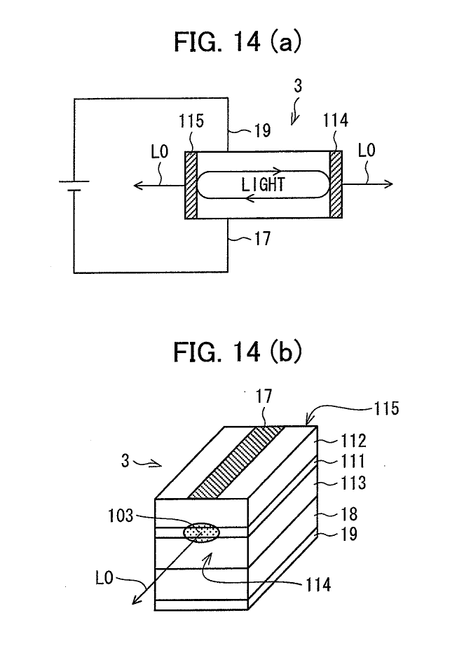

The following description discusses a fundamental structure of the laser diode 3. (a) of FIG. 14 is a view schematically illustrating a circuit diagram of the laser diode 3. (b) of FIG. 14 is a perspective view illustrating a fundamental structure of the laser diode 3. As illustrated in FIG. 14, the laser diode 3 includes: a cathode electrode 19, a substrate 18, a clad layer 113, an active layer 111, a clad layer 112, and an anode electrode 17, which are stacked in this order.

The substrate 18 is a semiconductor substrate. In order to obtain excitation light such as from blue excitation light to ultraviolet excitation light so as to excite a fluorescent material as in the present invention, it is preferable that the substrate 18 be made of GaN, sapphire, and/or SiC. Generally, for example, a substrate for the laser diode is constituted by: a IV group semiconductor such as that made of Si, Ge, or SiC; a III-V group compound semiconductor such as that made of GaAs, GaP, InP, AlAs, GaN, InN, InSb, GaSb, or MN; a II-VI group compound semiconductor such as that made of ZnTe, ZeSe, ZnS, or ZnO; oxide insulator such as ZnO, Al₂O₃, SiO₂, TiO₂, CrO₂, or CeO₂; or nitride insulator such as SiN.

The anode electrode 17 injects an electric current into the active layer 111 via the clad layer 112.

The cathode electrode 19 injects, from a bottom of the substrate 18 and via the clad layer 113, an electric current into the active layer 111. The electrical current is injected by applying forward bias to the anode electrode 17 and the cathode electrode 19.

The active layer 111 is sandwiched between the clad layer 113 and the clad layer 112.

Each of the active layer 111 and the clad layers 112 and 113 is constituted by, so as to obtain excitation light such as from blue excitation light to ultraviolet excitation light, a mixed crystal semiconductor made of AlInGaN. Generally, each of an active layer and clad layer of the laser diode is constituted by a mixed crystal semiconductor, which contains as a main composition Al, Ga, In, As, P, N, and/or Sb. The active layer and clad layers in accordance with the present invention can also be constituted by such a mixed crystal semiconductor. Alternatively, the active layer and clad layers can be constituted by a II-VI group compound semiconductor such as that made of Zn, Mg, S, Se, Te, and/or ZnO.

The active layer 111 emits light upon injection of the electric current. The light emitted from the active layer 111 is kept within the active layer 111, due to differences in refractive indices between the active layer 111 and the clad layer 112 and between the active layer 111 and the clad layer 113.

The active layer 111 further has a front cleavage surface 114 and a back cleavage surface 115, which face each other so as to keep, within the active layer 111, light that is enhanced by induced emission. The front cleavage surface 114 and the back cleavage surface 115 serve as mirrors.

Note however that, unlike a mirror that reflects light completely, the front cleavage surface 114 and the back cleavage surface 115 (for convenience of description, these are collectively referred to as the front cleavage surface 114 in the present embodiment) of the active layer 111 transmit part of the light enhanced due to induced emission. The light emitted outward from the front cleavage surface 114 is excitation light L0. The active layer 111 can have a multilayer quantum well structure.

The back cleavage surface 115, which faces the front cleavage surface 114, has a reflection film (not illustrated) for laser oscillation. By differentiating reflectance of the front cleavage surface 114 from reflectance of the back cleavage surface 115, it is possible for most of the excitation light L0 to be emitted from a luminous point 103 of an end surface having low reflectance (e.g., the front cleavage surface 114).

Each of the clad layer 113 and the clad layer 112 can be constituted by: a n-type or p-type III-V group compound semiconductor such as that made of GaAs, GaP, InP, AlAs, GaN, InN, InSb, GaSb, or AlN; or a n-type or p-type II-VI group compound semiconductor such as that made of ZnTe, ZeSe, ZnS, or ZnO. The electrical current can be injected into the active layer 111 by applying forward bias to the anode electrode 17 and the cathode electrode 19.

A semiconductor layer such as the clad layer 113, the clad layer 112, and the active layer 111 can be formed by a commonly known film formation method such as MOCVD (metal organic chemical vapor deposition), MBE (molecular beam epitaxy), CVD (chemical vapor deposition), laser-ablation, or sputtering. Each metal layer can be formed by a commonly known film formation method such as vacuum vapor deposition, plating, laser-ablation, or sputtering.

### (Principle of Light Emission of Light Emitting Part 7)

Next, the following description discusses a principle of a fluorescent material emitting light upon irradiation with a laser beam emitted from the laser diode 3.

First, the fluorescent material contained in the light emitting part 7 is irradiated with the laser beam emitted from the laser diode 3. Upon irradiation with the laser beam, an energy state of electrons in the fluorescent material is excited from a low energy state into a high energy state (excitation state).

After that, since the excitation state is unstable, the energy state of the electrons in the fluorescent material returns to the low energy state (an energy state of a ground level, or an energy state of an intermediate metastable level between ground and excited levels) after a certain period of time.

As described above, the electrons excited to be in the high energy state returns to the low energy state. In this way, the fluorescent material emits light.

Note here that, white light can be made by mixing three colors which meet the isochromatic principle, or by mixing two colors which are complimentary colors for each other. The white light can be obtained by combining (i) a color of the laser beam emitted from the laser diode 3 and (ii) a color of the light emitted from the fluorescent material on the basis of the foregoing principle and relation.

### (Note)

For example, a high-power LED can be used as the excitation light source. In this case, a light emitting device that emits white light can be achieved by combining (i) an LED that emits light at a wavelength of 450 nm (blue) and (ii) (a) a yellow fluorescent material or (b) green and red fluorescent materials.

Alternatively, a solid laser other than the laser diode, can be used as the excitation light source. Note however that the laser diode is preferable, because the laser diode makes it possible to downsize the excitation light source.

Further, the laser diode 3 and the light emitting part 7 can be a single body (i.e., the light guide is not necessary) so that the laser beam emitted from the laser diode 3 is appropriately received by the laser beam-irradiated surface 70a of the light emitting part 7.

The opening of the reflection mirror 8 is in a circular shape when viewed from a direct front thereof. Note however that the shape is not limited to the circular shape, and can be an ellipse shape or a rectangular shape etc. as long as the light reflected by the reflection mirror 8 is efficiently emitted outward.

An explanation was made above as to a case where each of the fluorescent material films 76a-76d is made of blue, green, and red fluorescent materials. However, the present invention is not limited to this case, and each of the fluorescent material films 76a-76d may be made of only one fluorescent material provided that a light emitting part may emit a single color (e.g. blue). Further, the present invention is not limited to the above two cases, and any combination of blue, green, and red fluorescent materials may be used in consideration of (i) allowable chromaticity of illumination light and (ii) a range of a wavelength of excitation light. Further, blue or green fluorescent material may be replaced with yellow fluorescent material for example.

Further, in a case where the headlamp 1 is designed such that the light emitting part 7 transmits a laser beam emitted from the laser diode 3 (such that light (fluorescence) converted from a laser beam incoming via the laser beam-irradiated surface 70a is emitted from the light emitting surface 70b), the reflection mirror 8 may be omitted provided that a converging lens such as the convex lens 14 is provided in front of the light emitting surface 70b. In this case, the reflection mirror 8 is not required to have a reflection function and is only required to serve as a member for supporting the transparent plate 9, the convex lens 14, the optical fiber 5 etc., and accordingly may be provided as a part of the housing 10 for example. The same can be said about a laser downlight 200 which will be mentioned later. In a case where the laser downlight 200 is designed such that the light emitting part 7 transmits a laser beam emitted from the laser diode 3, a concave portion 212 does not necessarily have a function of a reflection mirror (i.e. a metal thin film is not necessarily formed on the surface of the concave portion 212).

### Embodiment 2

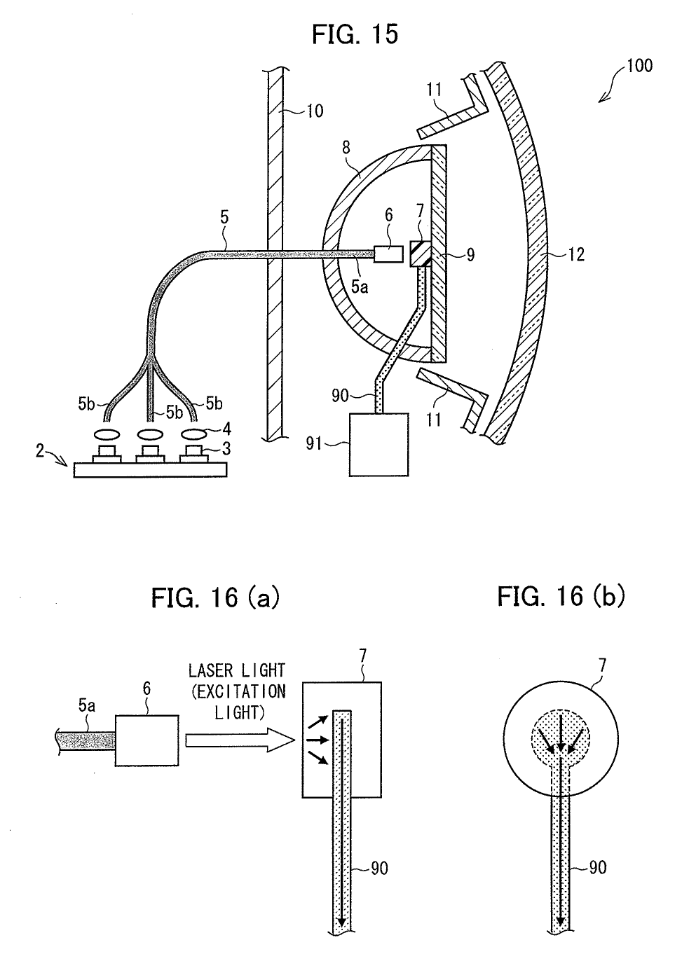

The following explains another embodiment of the present invention with reference to FIGS. 15-23. In Embodiment 2 as well as in Embodiment 1, an example of an illuminating device of the present invention described in the explanations is a headlamp (light emitting device, illuminating device, vehicle headlamp) 100 which is a passing headlamp for an automobile. For convenience of explanation, members having the same functions are given the same reference numerals and explanations thereof are omitted here. However, members given the same reference numerals but having different functions and/or shapes from those in Embodiment 1 are explained here in terms of their differences.

The headlamp 100 may meet the light distribution property standard for a driving headlamp (high beam) or may meet the light distribution property standard for a passing headlamp (low beam).

In the following, an explanation will be made on the premise that an optical fiber 5 illustrated in FIG. 15 is a bundle of a plurality of optical fibers (that is, includes a plurality of exit end parts 5a). Alternatively, the optical fiber 5 may be made of only one optical fiber (that is, include only one exit end part 5a). Further, in FIG. 15, for convenience of drawing, only one exit end part 5a is illustrated. However, the number of the exit end part 5a is not limited to one.

### (Configuration of Headlamp 100)

The following explains a configuration of the headlamp 100 with reference to FIG. 15. FIG. 15 is a cross sectional view illustrating a configuration of the headlamp 100. As illustrated in FIG. 15, the headlamp 100 includes a laser diode array 2, aspheric lenses 4, the optical fiber 5, a ferrule 6, a light emitting part 7, a reflection mirror 8, a transparent plate 9, a housing 10, an extension 11, and a lens 12.

The laser diode array 2, the aspheric lenses 4, the optical fiber 5, the ferrule 6, the reflection mirror 8, the housing 10, the extension 11, and the lens 12 are the same as those in Embodiment 1 and so explanations thereof are omitted here. The reflection mirror 8 has the same shape as the reflection mirror used in the modification example of the headlamp 1 in accordance with Embodiment 1. Further, laser diodes 3 included in the laser diode array 2 are the same as those in Embodiment 1 and so explanations thereof are omitted here.

The light emitting part 7 contains, so as to emit light upon receiving the laser beams emitted from the exit end part 5a, fluorescent materials each of which emits light upon receiving a laser beam. Specifically, the light emitting part 7 is made of silicone resin, which serves as a fluorescent material-holding substance and in which the fluorescent materials are dispersed. A ratio of the silicone resin to the fluorescent materials is approximately 10:1. The light emitting part 7 can also be made by ramming the fluorescent materials. The fluorescent material-holding substance is not limited to the silicone resin, and can be so-called organic-inorganic hybrid glass or inorganic glass.

Each of the fluorescent materials is a kind of oxynitride and/or nitride. The fluorescent materials, which are dispersed in the silicone resin, are blue, green, and red fluorescent materials. The basic structure of the light emitting device will explained later.

The light emitting part 7 is for example in a shape of a cylinder solid of 3.2 mm in diameter and 1 mm in thickness, and receives, at a light receiving surface thereof, a laser beam emitted from the exit end part 5a. The light receiving surface of the light emitting part 7 is one side of the cylinder solid which side faces the ferrule 6. The light receiving surface is a laser beam-irradiated surface of the light emitting part 7.

The light emitting part 7 may be a rectangular parallelepiped instead of a cylinder solid. For example, the light emitting part 7 may be a rectangular parallelepiped having dimensions of 3 mm×1 mm×1 mm. In this case, an area size of the laser beam-irradiated surface which receives the laser beams from the laser diodes 3 is 3 mm². Note here that a light distribution pattern (light distribution), of the vehicle headlamp, which is specified under the laws of Japan, is narrow in a vertical direction and wide in a horizontal direction. In view of this, the light emitting part 7 having a horizontally long shape (a cross-sectional surface of the light emitting part 7 is substantially rectangular) makes it easy to achieve such a light distribution pattern.

As illustrated in FIG. 15, the light emitting part 7 is positioned on the inner surface of the transparent plate 9 (which surface faces the exit end part 5a) so as to face the exit end part 5a (this position may be hereinafter referred to as “light-emitting-part-fixing position”). The light emitting part 7 is fixed to the light-emitting-part-fixing position by a heat-releasing supporter (heat-conducting member) 90. The heat-releasing supporter 90 is a line-shaped (including bar-shaped and cylinder-shaped) member extending from the reflection mirror 8. In a case where the heat-releasing supporter 90 is shaped cylindrically, circulating or flowing a liquid or a gas in the cylinder enables further increasing a heat-releasing effect.

As described above, the heat-releasing supporter 90 is a line-shaped member, one end of which (this end may be hereinafter referred to as “light-emission end”) is connected with the light emitting part 7 and the other end (this end may be hereinafter referred to as “cooling end”) is connected with a cooling device 91. Since the heat-releasing supporter 90 is shaped as above and connected as above, the heat-releasing supporter 90 supports the minute light emitting part 7 at the light-emitting-part-fixing position and at the same time releases heat generated from the light emitting part 7 to the outside of the headlamp 100.

Specifically, the light-emission end of the heat-releasing supporter 90 is embedded inside the light emitting part 7 by a predetermined length, and this embodiment connects the light emitting part 7 with the heat-releasing supporter 90. A position at which the light emitting part 7 is embedded into the heat-releasing supporter 90, i.e. a position at which the light emitting part 7 is connected with the heat-releasing supporter 90, is set so that a temperature-increase region including an irradiated region of the light emitting part 7 which region is irradiated with a laser beam (region of the laser beam-irradiated surface) and a region near the irradiated region in the housing 10 is cooled down.

The cooling device 91 is for releasing, from the heat-releasing supporter 90, heat which has been generated from the light emitting part 7 and which has been propagated from the light-emission end of the heat-releasing supporter 90 to the cooling end thereof. Needless to say, the cooling device 91 is not essential for the headlamp 100. For example, the headlamp 100 may be designed such that heat which has been propagated in the heat-releasing supporter 90 is merely released at the cooling end without using the cooling device 91. The point is that provision of the cooling device 91 enables efficiently releasing heat from the heat-releasing supporter 90. In particular, in a case where the amount of heat from the light emitting part 7 is 3 W or more, provision of the cooling device 91 is effective.

In FIG. 15, the heat-releasing supporter 90 is line-shaped. Alternatively, the heat-releasing member 90 may be made of a flexible material whose shape can be changed (which can be bent) as with the optical fiber 5.

The flexible material may be a metal. Generally, a metal is flexible and shaping the metal to be at least a line enables the metal to be a bendable member. In particular, in cases of silver, gold, copper, aluminum etc. having high thermal conductivity, shaping the metal to be a thin line whose diameter is smaller than 1 mm enables the metal to be easily bent by human hands, and therefore such metal is preferable as a material for the heat-releasing supporter 90. When the size of the light emitting part 7 is in the order of 1 mm, the diameter of the heat-releasing supporter 90 is less than 1 mm.

In addition to the above metals, graphite may be used for example. By shaping graphite to be a sheet of 0.1 mm in thickness, it is possible to make graphite flexible.

Further, quartz which is commonly used as a material for an optical fiber may be used for the heat-releasing supporter 90. By shaping quartz to have a core diameter of approximately 1 mm or less, it is possible to make quartz flexible.

In the case where the heat-releasing supporter 90 is flexible, it is possible to easily change a relative positional relationship between the light emitting part 7 and the cooling device 91. Further, by changing the length of the heat-releasing supporter 90, it is possible to position the cooling device 91 to be away from the light emitting part 7. In this case, the position of the cooling device 91 is not limited to the inside of the housing 10 as illustrated in FIG. 15. The cooling device 91 may be positioned to be outside of the housing 10 by the heat-releasing supporter 90 penetrating the housing 10, as with the configuration in which the optical fiber 5 penetrates the housing 10.

Therefore, the cooling device 91 may be positioned at a place at which the cooling device 91 would be easily repaired or replaced if the cooling device 91 were in trouble. This increases flexibility in design of the headlamp 100.

Specific configurations of the heat-releasing supporter 90 and the cooling device 91 will be detailed later.

The transparent plate 9 fixes, in corporation with the heat-releasing supporter 90, the light emitting part 7 at the light-emitting-part-fixing position. Needless to say, the light emitting part 7 may be fixed at the light-emitting-part-fixing position only by the heat-releasing supporter 90 without using the transparent plate 9.

As described above, the headlamp 100 in accordance with the present embodiment includes: laser diodes 3 for emitting a laser beam; the optical fiber 5 having the entrance end parts 5b for receiving the laser beam emitted from the laser diodes 3 and the exist end part 5a for emitting the laser beam received via the entrance end parts 5b; the light emitting part 7 for emitting light upon irradiation with the laser beam emitted from the exit end part 5a; and the heat-releasing supporter 90 for releasing heat generated from a temperature-increase region including an irradiated region of the light emitting part 7 which region is irradiated with the laser beam and a region in the vicinity of the irradiated region and for fixing the light emitting part 7 at the light-emitting-part-fixing position.

The headlamp 100 in accordance with the present embodiment may further include the cooling device 91 for efficiently releasing heat propagated in the heat-releasing supporter 90.

The inventor of the present invention and the inventor's colleagues have found that when the light emitting part 7 is excited by a high power laser beam, the light emitting part 7 deteriorates greatly. The deterioration of the light emitting part 7 is caused mainly by (i) deterioration of fluorescent materials themselves included in the light emitting part 7 and (ii) a substance (e.g. silicone resin) surrounding the fluorescent materials. The aforementioned sialon fluorescent material and nitride fluorescent material emit light with an efficiency of 60-90% upon irradiation with a laser beam, but the rest of the laser beam is converted into heat and released. It is considered that the heat deteriorates the substance surrounding the fluorescent material.

In order to deal with this problem, the headlamp 100 is designed as above and prevents an increase in temperature of a temperature-increase region, thereby achieving a long-life light source. That is, the headlamp 100 can serve as a high-luminance light source with high reliability.

### (Heat-Releasing Supporter 90)

With reference to FIGS. 16-20, the following specifically explains a configuration of the heat-releasing supporter 90 and how the light emitting part 7 and the heat-releasing supporter 90 are connected with each other. It should be noted that the drawings are schematic, and a relation between a thickness and plan dimensions, a ratio in thickness between individual portions etc. do not reflect actual numeral values. Accordingly, concrete thickness and dimensions should be determined in consideration of the following explanation. Needless to say, there are differences in dimensions and ratios between individual drawings.

In FIGS. 16-20, modification examples of the aforementioned components are drawn. These modification examples are given reference numerals which are combinations of reference numerals of the corresponding components mentioned above and alphabets following the reference numerals, thereby showing that they are modification examples while showing correspondences between the components mentioned above and the modification examples.

### (First Example of Connection)

FIG. 16 is a view illustrating a first example of connection between the light emitting part 7 and the heat-releasing supporter 90. (a) of FIG. 16 is a cross sectional view of the connection, and (b) of FIG. 16 is an elevation view of the connection. In the first example, the heat-releasing supporter 90 may be made of a metal such as aluminum, silver, gold, and copper. Alternatively, instead of such a metal, graphite having higher thermal conductivity than the metal may be used. Such a metal and graphite have higher thermal conductivity than the light emitting part 7.

As illustrated in (b) of FIG. 16, a portion of the light-emission end of the heat-releasing supporter 90 which portion is embedded in the light emitting part 7 is shaped in such a manner that when seen from the ferrule 6, a part of that portion which part is behind a laser beam-irradiated region of the laser beam-irradiated surface of the light emitting part 7 has a larger area than other part of that portion. This area is determined according to the area of the laser beam-irradiated region. This configuration enables efficiently collecting heat generated from a temperature-increase region including the laser beam-irradiated region and its neighboring region. In particular, in a case where the part with a larger area of the light-emission end of the heat-releasing supporter 90 is shaped to include the laser-beam irradiated region when seen from the ferrule 6, it is possible to efficiently collect heat generated from a temperature-increase region.

Further, as illustrated in (a) of FIG. 16, the light-emission end of the heat-releasing supporter 90 is not embedded in the whole area of the laser beam-irradiated surface of the light emitting part 7 when seen from the ferrule 6. That is, in order that a laser beam entering the light emitting part 7 via a laser beam-irradiated surface travels toward a surface positioned oppositely to the laser beam-irradiated surface, there is provided a space which is not occupied by the heat-releasing supporter 90. Consequently, even when the heat-releasing supporter 90 is made of a material with a light blocking effect such as a metal and graphite, the entering laser beam can travel to the surface positioned oppositely to the laser beam-irradiated surface, so that fluorescence generated by the fluorescent materials of the light emitting part 7 can be obtained from the surface positioned oppositely to the laser beam-irradiated surface.

In the above, the heat-releasing supporter 90 is made of a metal, graphite or the like. Alternatively, the heat-releasing supporter 90 may be made of a transparent material having translucency. Specifically, there may be used a member obtained by forming a transparent conductive film (e.g. ITO film) on a surface of quartz or alumina whose thermal conductivity is lower than that of the aforementioned metal or graphite but is higher than that of the light emitting part 7.

### (Second Example of Connection)

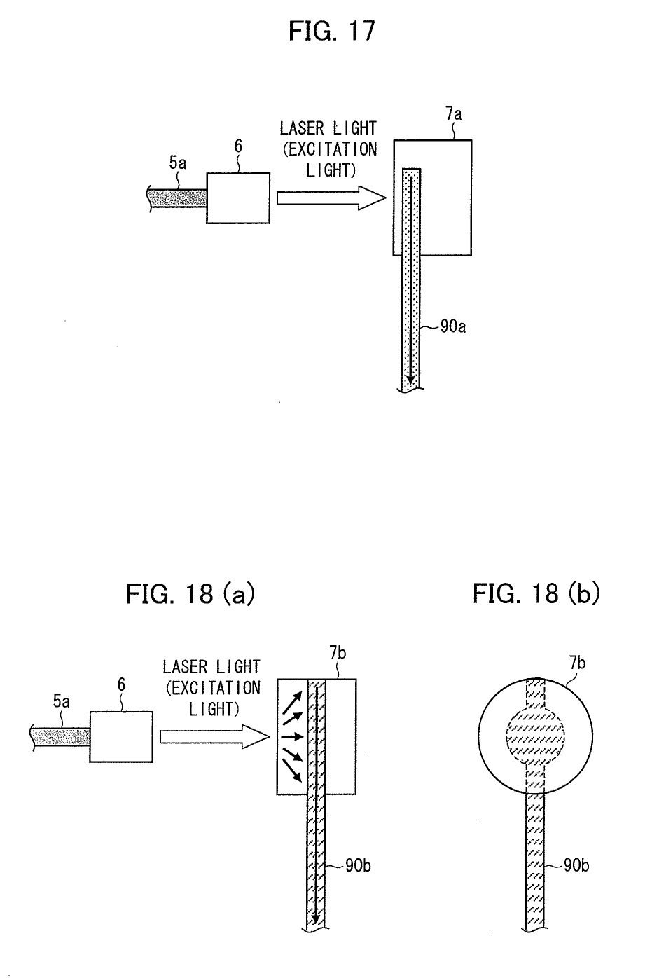

FIG. 17 is a view illustrating a second example of connection between a light emitting part 7a and a heat-releasing supporter 90a. In the second example, unlike the first example illustrated in FIG. 16, the heat-releasing supporter 90a is embedded in the light emitting part 7a in such a manner as to be closer to a laser beam-irradiated surface of the light emitting part 7a.

That is, in the second example, a distance between a light-emission end of the heat-releasing member 90a and a temperature-increase region including a laser beam-irradiated region of the light emitting part 7a and a region in the vicinity of the laser beam-irradiated region is shorter than that of the first example.

Consequently, heat generated in the temperature-increase region of the light emitting part 7a can be released quickly, so that less heat is accumulated in the temperature-increase region. Thus, an increase in temperature is prevented.

Also in the second example, the heat-releasing supporter 90a may be made of the aforementioned material having translucency.

### (Third Example of Connection)

FIG. 18 is a view illustrating a third example of connection between a light emitting part 7b and a heat-releasing supporter 90b. (a) of FIG. 18 is a cross section of the connection and (b) of FIG. 18 is an elevation view of the connection. In the third example, the heat-releasing supporter 90b is made of the aforementioned material having translucency.

The third example is different from the first and second examples in that as illustrated in (a) of FIG. 18 and (b) of FIG. 18, the light-emission end of the heat-releasing supporter 90b is embedded in the light emitting part 7 in such a manner that the heat-releasing supporter 90b penetrates the light emitting part 7.

Consequently, the light-emission end of the heat-releasing supporter 90b which end can collect heat generated in a temperature-increase region including a laser beam-irradiated region of the light emitting part 7b and a region in the vicinity of the laser beam-irradiated region is large, so that it is possible to more efficiently collect heat generated in the temperature-increase region.

The heat-releasing supporter 90b may be made of the aforementioned material having translucency.

Further, the heat-releasing supporter 90b may be made of the aforementioned metal or graphite. In this case, the heat-releasing supporter 90b made of the metal etc. having higher thermal conductivity enables more efficiently collecting heat generated in the temperature-increase region of the light emitting part 7b.

### (Fourth Example of Connection)

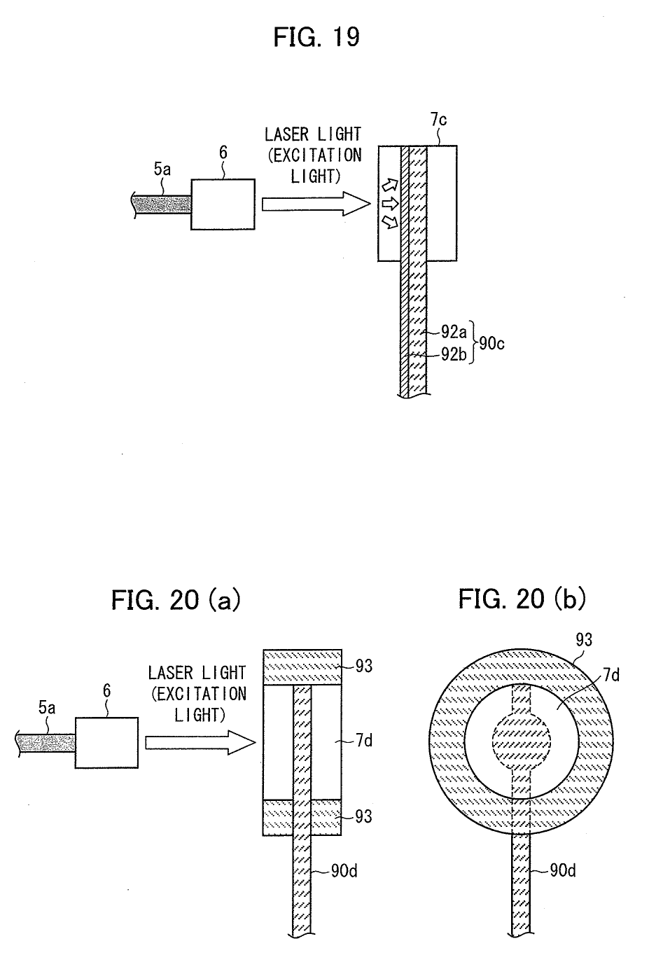

FIG. 19 is a view illustrating a fourth example of connection between a light emitting part 7c and a heat-releasing supporter 90c. The fourth example is different from the third example in that the heat-releasing supporter 90c is obtained by laminating a first member 92a made of the aforementioned metal or graphite and a second member (reflecting layer) 92b which is positioned closer to a laser beam-irradiated side of the first member 92a and which reflects a laser beam.

In the fourth example, it is possible to double the length of a path via which a laser beam is converted into fluorescence, so that it is possible to obtain more amount of fluorescence from the light emitting part 7c. This is because the laser beam can be converted into fluorescence both via a path in which a laser beam entering the light emitting part 7c travels to the second member 92b and via a path in which the laser beam travels from the second member 92b and outgoes from the light emitting part 7c again.

Therefore, the fourth example is effective when it is necessary to obtain fluorescence from the laser beam-irradiated surface of the light emitting part 7.

In the above, the heat-releasing supporter 90c is obtained by laminating the first member and the second member. The same effect can be obtained by designing the first member to have a mirror-finished surface, instead of using the second member.

### (Fifth Example of Connection)

FIG. 20 is a view illustrating a fifth example of connection between a light emitting part 7d and a heat-releasing supporter 90d. (a) of FIG. 20 is a cross section of the connection and (b) of FIG. 20 is an elevation view of the connection. The fifth example is different from the third example illustrated in (a) of FIG. 18 and (b) of FIG. 18 in that a heat-releasing member 93 is positioned around the light emitting part 7b and the heat-releasing member 93 is connected with a light-emission end of the heat-releasing supporter 90d.

In the fifth example, heat collected to a light-emission end of the heat-releasing supporter 90d can be released not only via a cooling end of the heat-releasing supporter 90d but also via the heat-releasing member 93. Consequently, heat can be released more efficiently from the heat-releasing supporter 90d.

The heat-releasing member 93 may be made of the aforementioned metal or graphite for example.

### (Cooling Device 91)

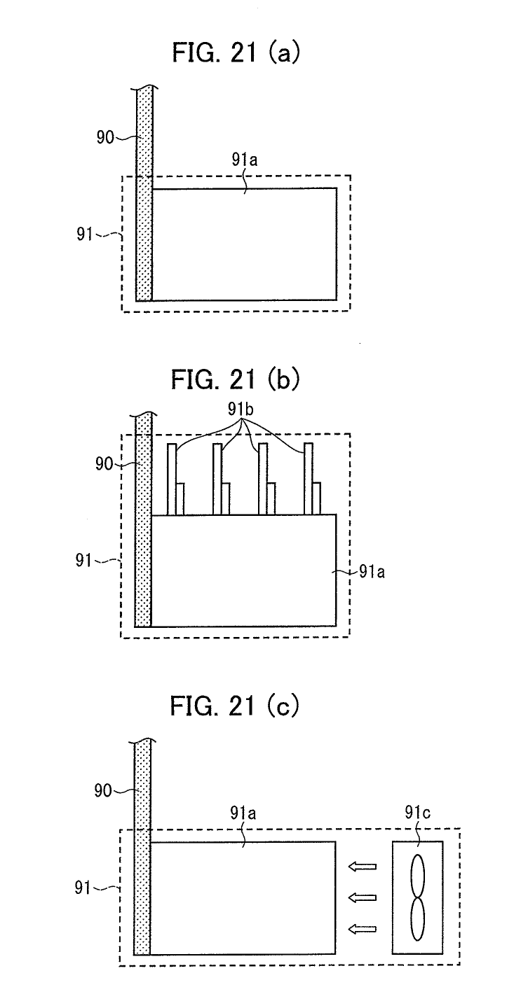

The following specifically explains a configuration of the cooling device 91 with reference to FIG. 21.

A first example illustrated in (a) of FIG. 21 is an example in which the cooling end of the heat-releasing supporter 90 contacts a metal block 91a. The metal block 91a is preferably made of aluminum or copper.

In the first example, heat collected to the light-emission end of the heat-releasing supporter 90 is efficiently released from the metal block 91a.

A second example illustrated in (b) of FIG. 21 is an example in which the metal block 91a illustrated in (a) of FIG. 21 has, on an upper surface thereof, a plurality of heat-releasing fins 91b.

In the second example, heat can be more efficiently released from the metal block 91a.

A third example illustrated in (c) of FIG. 21 is an example in which a wind is generated to blow the metal block 91a illustrated in (a) of FIG. 21 so that heat is more efficiently released from the metal block 91a.

In the third example, a blower 91c having a structure of a normal electric fan may be used.

In another example, a pipe may be provided inside the metal block 91a and a liquid cooling (water cooling) mechanism for circulating cooling water etc. in the pipe may be provided.

### EFFECT OF THE PRESENT INVENTION

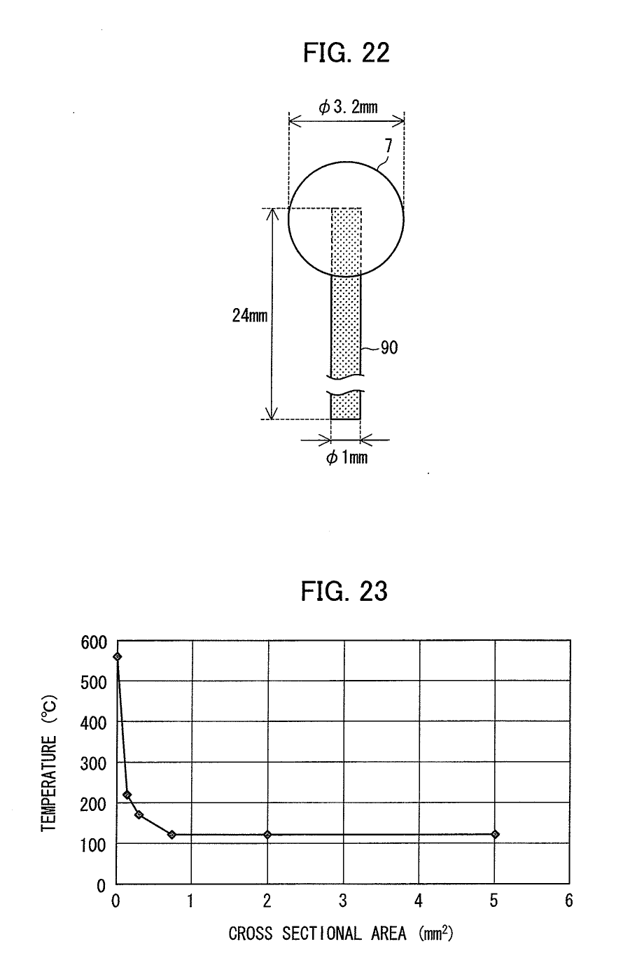

The following explains an example of test data regarding prevention of temperature increase. The test was carried out using the light emitting part 7 and the heat-releasing supporter 90 illustrated in FIG. 22.

In FIG. 22, the heat-releasing supporter 90 was made of copper (thermal conductivity at room temperature: 400 W/mK), and had a length of 24 mm. The cross sectional area of the heat-releasing supporter 90 was changed as shown in Table 1.

TABLE 1

| Cross sectional | Temperature |
|---|---|
| area (mm²) | (° C.) |
| 0 | 560 |
| 0.15 | 220 |
| 0.3 | 170 |
| 0.75 | 120 |
| 2 | 120 |
| 5 | 120 |

The light emitting part 7 had a cylindrical shape of 3.2 mm in diameter and 1 mm in thickness. The heat-releasing supporter 90 was embedded inside the light emitting part 7. Fluorescent materials dispersed in the light emitting part 7 had a luminous efficiency of 80%.

The light emitting part 7 and the heat-releasing supporter 90 as above were irradiated with a laser beam of 5 W. As a result, 4 W was converted into fluorescence and remaining 1 W was converted into heat.

FIG. 23 shows an effect of preventing an increase in temperature of the light emitting part 7. As seen from FIG. 23, when the heat-releasing supporter 90 of 0.75 mm² in cross sectional area (substantially corresponding to a shaft of 1 mm in diameter) was used, it was possible to cool the light emitting part 7 down to 120° C., whereas when the heat-releasing supporter 90 was not used, the light emitting part 7 was at 560° C.

### Embodiment 3

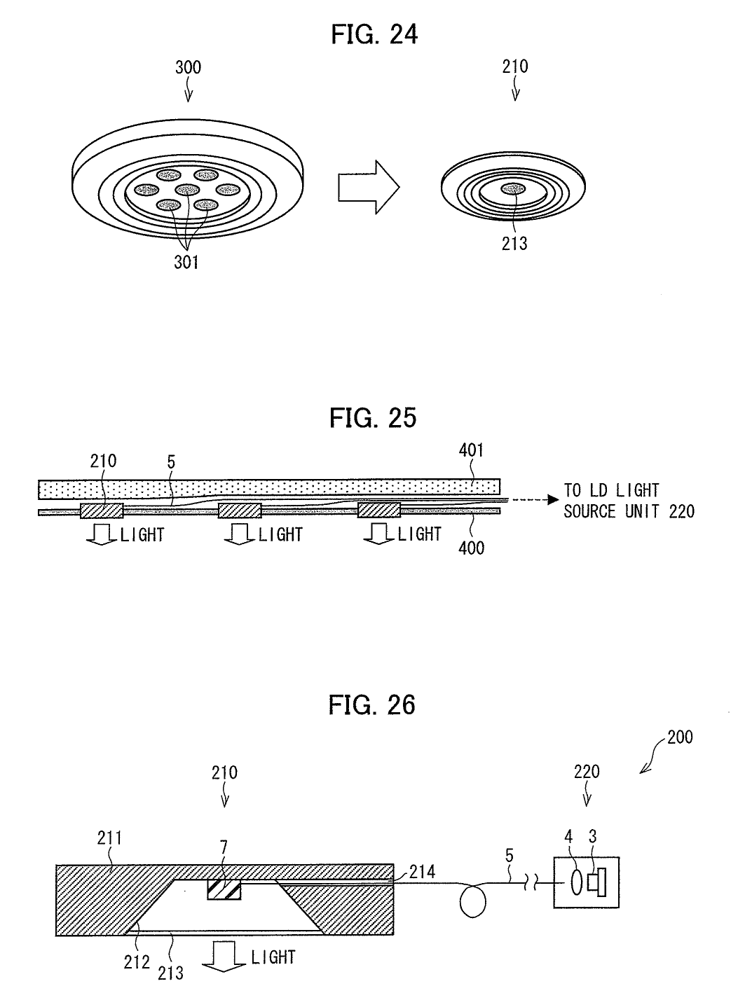

The following explains another embodiment of the present invention with reference to FIGS. 24-29. The present embodiment relates to a laser downlight which is a concrete example of an illuminating device using the light emitting device of Embodiment 1 or 2 above. Members having the same functions as those in Embodiment 1 or 2 are given the same reference numerals and explanations thereof are omitted here.

An explanation is made here as to a laser downlight 200 which is an example of an illuminating device of the present invention. The laser downlight 200 is an illuminating device to be installed into a ceiling of a structure such as a house and a vehicle. The laser downlight 200 uses, as illumination light, fluorescence generated when the light emitting part 7 is irradiated with a laser beam emitted from the laser diodes 3.

An illuminating device having a configuration similar to that of the laser downlight 200 may be installed into a side wall or a floor of a structure. Where the illuminating device is installed is not particularly limited.

FIG. 24 is a view schematically illustrating appearances of a light emitting unit 210 and a conventional LED downlight 300. FIG. 25 is a cross sectional view illustrating a ceiling where the laser downlight 200 is installed. FIG. 26 is a cross sectional view of the laser downlight 200. As illustrated in FIGS. 24-26, the laser downlight 200 includes the light emitting unit 210 which is embedded in a ceiling panel 400 and emits illumination light, and an LD light source unit 220 which supplies a laser beam to the light emitting unit 210 via an optical fiber 5. The LD light source unit 220 is not installed into the ceiling but is installed at a position where a user can easily touch the LD light source unit 220 (e.g. side wall of a house). The position of the LD light source unit 220 can be freely determined as above because the LD light source unit 220 and the light emitting unit 210 are connected with each other via the optical fiber 5. The optical fiber 5 is provided at a space between the ceiling 400 and a thermal insulator 401.

### (Configuration of Light Emitting Unit 210)

As illustrated in FIG. 26, the light emitting unit 210 includes a housing 211, the optical fiber 5, the light emitting part 7, and a transparent plate 213.

The housing 211 has a recess 212, and the light emitting part 7 is provided on the bottom surface of the recess 212. The surface of the recess 212 is coated with a metal thin film so that the recess 212 serves as a reflection mirror.

Further, the housing 211 has a path 214 via which the optical fiber 5 extends to the light emitting part 7. The positional relationship between the exit end part 5a of the optical fiber 5 and the light emitting part 7 is the same as that explained above.

The transparent plate 213 is a transparent or semi-transparent plate positioned in such a manner as to seal an opening of the recess 212. The transparent plate 213 has the same function as the transparent plate 9. Fluorescence emitted from the light emitting part 7 passes through the transparent plate 213 and is emitted as illumination light. The transparent plate 213 may be removable from the housing 211 or may be omitted.

In FIG. 24, the light emitting unit 210 has a circularly shaped outer periphery. However, the shape of the light emitting unit 210 (to be more exact, the shape of the housing 211) is not particularly limited.

It should be noted that a downlight is not required to have an ideal point light source unlike a headlamp, and is only required to have one luminous point. Therefore, the shape, the size, and the position of the light emitting part 7 are less limited than those of a headlamp.

In a case where the laser downlight 200 includes the light emitting device in accordance with Embodiment 2, the light emitting part 7 is fixed by a heat-releasing supporter 90 (not illustrated) as in Embodiment 2, and one end (light-emission end) of the heat-releasing supporter 90 is connected with the light emitting part 7 and the other end (cooling end) is connected with a cooling device 91 (not illustrated).

### (Configuration of LD Light Source Unit 220)

The LD light source unit 220 includes a laser diode 3, an aspheric lens 4, and an optical fiber 5.

An entrance end part 5b which is one end of the optical fiber 5 is connected with the LD light source unit 220, and a laser beam emitted from the laser diode 3 enters the entrance end part 5b of the optical fiber 5 via the aspheric lens 4.

In the LD light source unit 220 illustrated in FIG. 26, only one pair of the laser diode 3 and the aspheric lens 4 is illustrated. In a case where there are a plurality of light emitting units 210, a bundle of the optical fibers 5 respectively extending from the plurality of light emitting units 210 may lead to one LD light source unit 220. In this case, one LD light source unit 220 includes plural pairs of the laser diode 3 and the aspheric lens 4 (alternatively, a plurality of laser diodes 3 and one rod lens (aspheric lens 4 illustrated in FIG. 12), and so the LD light source unit 220 serves as an integrated power source box.

### (Modification Example of how to Install Laser Downlight 200)

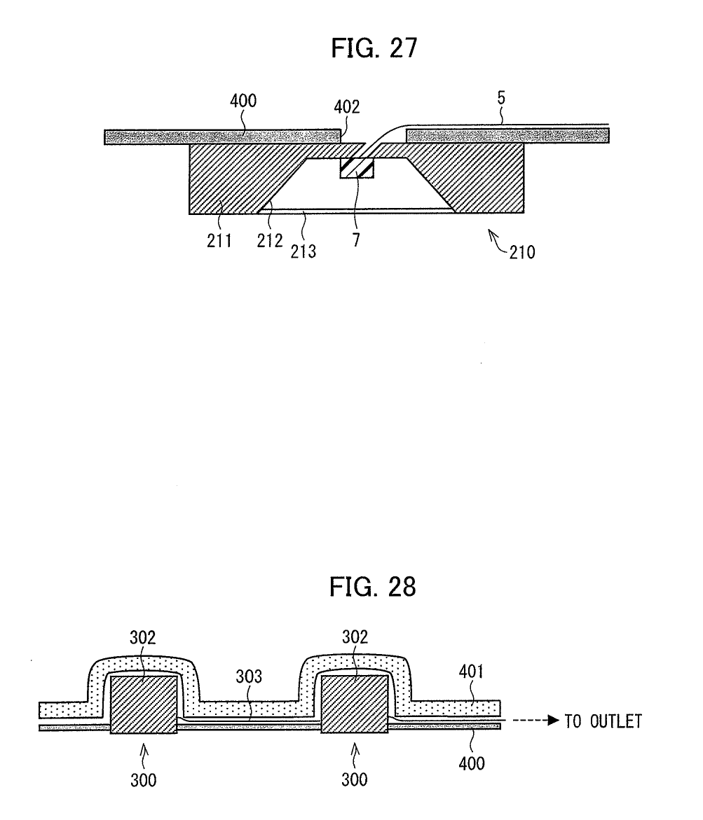

FIG. 27 is a cross sectional view illustrating a modification example of how to install the laser downlight 200. As illustrated in FIG. 27, the laser downlight 200 may be installed in such a manner that only a hole 402 via which the optical fiber 5 runs through is made in the ceiling panel 400 and the laser downlight itself (light emitting unit 210) is attached to the ceiling panel 400 by taking advantage of characteristics (thin and light-weighted) of the light emitting unit 210. This configuration is advantageous in that installation of the laser downlight 200 is less restricted and costs for the installation can be greatly reduced.

### (Comparison of Laser Downlight 200 and Conventional LED Downlight 300)

As illustrated in FIG. 24, the conventional LED downlight 300 includes a plurality of transparent plates 301, and illumination light is emitted via individual transparent plates 301. That is, the LED downlight 300 has a plurality of luminous points. The reason why the LED downlight 300 has a plurality of luminous points is that luminous flux of light emitted from individual luminous points is relatively small and so a plurality of luminous points must be provided in order to assure light with luminous flux sufficient as illumination light.

In contrast thereto, the laser downlight 200 is an illuminating device with high luminous flux, and so the number of a luminous point for the laser downlight 200 may be one. This yields an effect that illumination light makes shades and shadows clear. Further, by using high color rendering fluorescent materials (e.g. any combination of plural kinds of oxynitride fluorescent material and/or nitride fluorescent material) in the light emitting part 7, it is possible to improve color rendering properties of illumination light.

This enables achieving high color rendering almost equal to that of an incandescent bulb. For example, light with high color rendering (general color rendering index Ra is 90 or more and special color rendering index R9 is 95 or more) which is difficult to be achieved by an LED downlight or a fluorescent lamp downlight can be achieved by combining a high color rendering fluorescent material with the laser diode 3.

FIG. 28 is a cross sectional view of a ceiling where the LED downlights 300 are installed. As illustrated in FIG. 28, in each of the LED downlights 300, a housing 302 containing an LED chip, a power source, and a cooling unit therein is embedded in the ceiling plate 400. The housing 302 is relatively large, and so the heat insulator 401 has a recess whose shape corresponds to the shape of the housing 302 and on which the housing 302 is positioned. A power source line 303 extends from the housing 302 and is connected with an outlet (not illustrated).

Such conventional configuration raises several problems. Initially, since a light source (LED chip) and a power source which generate heat are positioned between the ceiling panel 400 and the heat insulator 401, use of the LED downlight 300 results in an increase in temperature of the ceiling, which reduces the efficiency of cooling the room.

Second problem is that the LED downlight 300 requires a power source and a cooling unit with respect to each light source, resulting in an increase in total costs.

Third problem is that since the housing 302 is relatively large, it is often difficult to provide the LED downlight 300 between the ceiling panel 400 and the heat insulator 401.

In contrast thereto, in the laser downlight 200, the light emitting unit 210 does not include a large heat source, and so does not reduce the efficiency of cooling the room. This enables avoiding an increase in costs for cooling the room.

Further, in the laser downlight 200, it is unnecessary to provide a power source and a cooling unit with respect to each light emitting unit 210, the laser downlight 200 can be small and thin. This reduces a restriction on a space where the laser downlight 200 is installed, making it easier to install the laser downlight 200 into an existing house.

Further, since the laser downlight 200 is small and thin, the light emitting unit 210 can be provided on the surface of the ceiling 400 as described above, thereby reducing a restriction on installation of the laser downlight 200 and greatly reducing costs for the installation, compared with installation of the LED downlight 300.

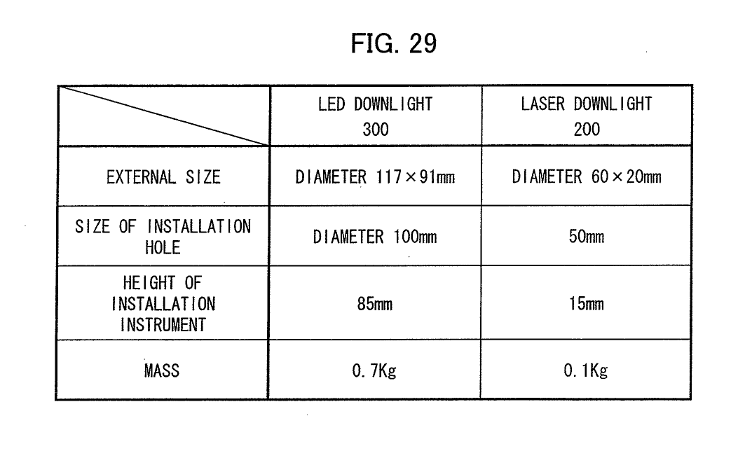

FIG. 29 shows a table in which specs of the laser downlight 200 and the LED downlight 300 are compared with each other. As illustrated in FIG. 29, the volume of one example of the laser downlight 200 is smaller by 94% than that of the LED downlight 300, and the mass of one example of the laser downlight 200 is smaller by 86% than that of the LED downlight 300.

Further, since the LD light source unit 220 can be provided at a place where a user can easily touch, it is possible to switch the laser diodes 3 easily when the laser diode 3 is in trouble. Further, by leading the optical fiber 5 extending from the plurality of light emitting units 210 to one LD light source unit 220, it is possible to manage the plurality of laser diodes 3 at once. Therefore, even when two or more laser diodes 3 are to be replaced with new ones, it is possible to easily replace them.

When the LED downlight 300 uses high color rendering fluorescent materials, the LED downlight 300 emits luminous flux of approximately 500 lm at a power consumption of 10 W. On the other hand, the laser downlight 200 requires light output of 3.3 W in order to achieve the same light. This light output corresponds to a power consumption of 10 W when LD efficiency is 35%. The power consumption of the LED downlight 300 is also 10 W, there is no significant difference in power consumption between the laser downlight 200 and the LED downlight 300. Therefore, the laser downlight 200 enjoys various advantages as above, with the same power consumption as that of the LED downlight 300.

As described above, the laser downlight 200 includes the LD light source unit 220 including at least one laser diode 3 for emitting a laser beam, at least one light emitting unit 210 including the light emitting part 7 and the recess 212 serving as a reflection mirror, and the optical fiber 5 which leads the laser beam to each of the at least one light emitting unit 210.

An example of the light emitting part 7 is, as described in Embodiment 1, obtained by depositing fluorescent materials for emitting light upon irradiation with a laser beam on the metal plate 75 with a predetermined shape so as to form the fluorescent material films 76a and 76b on the metal plate 75. In this case, the light emitting part 7 can be obtained only by depositing fluorescent materials on the easily shapable metal plate 75 to form the fluorescent material films 76a and 76b, and accordingly the light emitting part 7 can be easily shaped to have a desired shape (e.g. complicated shape) even if the light emitting part 7 is small. Consequently, it is possible to achieve the light emitting part 7 having a high utilization ratio of light. Further, the light emitting part 7 can be produced by thinly depositing the fluorescent material films 76a and 76b on the thin metal plate 75, the light emitting part 7 can be both small and thin. Further, by applying the light emitting part 7 to the laser downlight 200, it is possible for the laser downlight 200 to have a higher utilization ratio of light.

### [Further Configuration (1) of the Present Invention]

Further, the light emitting element etc. of the present invention may be expressed as follows based on Embodiments 1 and 3.

It is preferable to arrange the light emitting element of the present invention such that the conducting member has a plate-shape.

With the arrangement, since the conducting member has a plate-shape, it is easy to process the conducting member so that the conducting member has a desired shape. Further, since the conducting member has a plate-shape, it is possible to immerse the conducting member in a dispersion solvent containing fluorescent materials so that the conducting member serves as an electrode, thereby depositing the fluorescent materials on the surface of the conducting member. That is, by depositing the fluorescent materials on the surface of the conducting member by electrophoresis for example, it is possible to easily form a fluorescent material film on the surface. In order that the fluorescent materials are deposited by electrophoresis, it is desirable that the fluorescent materials are ionized.

As described above, merely by immersing the easily shapable conducting member in the dispersion solvent containing fluorescent materials and electrifying the conducting member, it is possible to easily achieve a light emitting element with a desired shape.

It is preferable to arrange the light emitting element of the present invention such that the fluorescent material film is formed by depositing the fluorescent material on a region of the conductive member which region is other than an insulating film with a predetermined pattern covering a surface of the conductive member.

With the arrangement, since the fluorescent material is deposited on a region other than the insulating film with a predetermined pattern, it is possible to form a fluorescent material film having the fluorescent material deposited according to the predetermined pattern. Accordingly, even if the shape of the conducting member does not meet a predetermined light distribution property (e.g. the shape of the conducting member is rectangular), it is possible to form a fluorescent material film with a predetermined shape. Therefore, by shaping the fluorescent material film to meet the light distribution property, it is possible to increase a utilization ratio of light.

When it is possible to deposit the fluorescent materials on the insulating film, the fluorescent materials deposited on a region other than the insulating film are thicker than the fluorescent materials deposited on the insulating film. Accordingly, it is possible to thicken the fluorescent materials deposited on, for example, a region of the light emitting element which region is strongly irradiated with excitation light. Therefore, it is possible to improve flexibility in design of the light emitting element.

Further, for example, after evaporating an insulating film on a surface of a conducting member, a predetermined pattern is formed on the insulating film. This enables forming the predetermined pattern minutely. Accordingly, even if it is impossible to realize a desired minute shape by shaping the conducting member, it is possible to achieve a fluorescent material film having the minute pattern by forming an insulating film with the predetermined pattern on the surface of the conducting member and depositing fluorescent materials according to the predetermined pattern. That is, it is possible to achieve a light emitting element with a minute pattern.

It is preferable to arrange the light emitting element of the present invention such that the fluorescent material films are formed on respective surfaces of the conductive member, and when one of the respective surfaces is a first surface and the other is a second surface, the first surface and the second surface are coated with insulating films with different patterns.

With the arrangement, fluorescent material films on the first and second surfaces of the conducting member respectively have insulating films with different patterns. Since fluorescent material films having fluorescent materials deposited according to respective predetermined patterns are formed on the first and second surfaces, the fluorescent material films respectively have regions where the fluorescent materials are deposited differently.

Consequently, it is possible to further increase a utilization ratio of light in the light emitting element and improve flexibility in design of the light emitting element, compared with a case where a fluorescent material film having an insulating film with a predetermined pattern is formed only on one side of a conducting member for example. Accordingly, the light emitting element is applicable more broadly.

It is preferable to arrange the light emitting element of the present invention such that the fluorescent material film is formed on a light receiving surface of the conductive member, the light receiving surface being a surface receiving excitation light, and an insulating film is formed on a surface of the conductive member which surface is positioned oppositely to the light receiving surface.

With the arrangement, the insulating film is formed on a surface of the conductive member which surface is positioned oppositely to the light receiving surface. That is, it is possible to achieve a light emitting element in which a fluorescent material film is formed on a light receiving surface of the light emitting element but a fluorescent material film is not formed on a surface positioned oppositely to the light receiving surface (i.e. a light emitting element in which a fluorescent material film is formed on only one side of the light emitting element).

There is a case where when a light emitting element is irradiated with strong excitation light, excitation light which is not converted into fluorescence at a fluorescent material film is converted into heat, resulting in an increase in temperature of the fluorescent material film. This case leads to a phenomenon that a ratio of converting the excitation light into fluorescence at the fluorescent material film drops and the temperature of the fluorescent material film is further increased (negative feedback).

Since the light emitting element of the present invention is designed such that the fluorescent material film is formed on only one surface of the conducting member, it is possible to attach the other surface (surface positioned oppositely to the light receiving surface) to a heat sink such as a metal block which is excellent in heat release. When the other surface is attached to a heat sink, it is possible to quickly release heat from the fluorescent material film, thereby preventing the fluorescent material film from dropping a ratio of converting excitation light into fluorescence.

It is preferable to arrange the light emitting element of the present invention such that the insulating film is made of an inorganic material.

With the arrangement, it is possible to avoid a possibility that an insulating film dissolves in electrophoresis when a solution for electrophoresis is a one based on an organic solvent for example.

It is preferable to arrange the light emitting element of the present invention such that the fluorescent material film is formed on a light receiving surface of the conductive member, the light receiving surface being a surface receiving excitation light, and a light reflecting member for reflecting light emitted from the fluorescent material film is formed on a surface of the conductive member which surface is positioned oppositely to the light receiving surface.

With the arrangement, the light reflecting member is formed on a surface of the conductive member which surface is positioned oppositely to the light receiving surface. Accordingly, light reflected by the light reflecting member can be emitted from the light receiving surface, so that light emitted from the light emitting element can be directed in a predetermined direction.

Further, even if excitation light entering the fluorescent material film via the light receiving surface is not converted by the fluorescent material film before arriving at the light reflecting member, the light reflecting member can reflect the unconverted light (excitation light) so that the light enters the fluorescent material film again without going out of the light emitting element. This enables surely converting the excitation light entering the light emitting element. Further, since the light emitting element prevents the excitation light from going out of the light emitting element, the light emitting element is highly safe.

It is preferable to arrange the light emitting element of the present invention such that the conductive member is transparent.

With the arrangement, the conductive member is transparent, so that light converted by the fluorescent material film can be surely emitted to the outside of the light emitting element.

It is preferable to arrange the light emitting element of the present invention such that the conductive member has a conducting terminal to be connected with a power source for forming the fluorescent material film on the surface of the conductive member by electrophoresis, and the conducting terminal is coated with an insulating film.

With the arrangement, the conductive member has a conducting terminal coated with an insulating film. Accordingly, it is possible to prevent the fluorescent material from being deposited on the surface of the conducting terminal by electrophoresis. Therefore, by connecting the conducting terminal on which the fluorescent material is not deposited with the power source for forming the fluorescent material film on the surface of the conductive member by electrophoresis, it is possible to easily use the light emitting element as an electrode for electrophoresis.

It is preferable that a light emitting device of the present invention includes: the aforementioned light emitting element; and an excitation light source for emitting the excitation light, the light emitting element emitting light upon irradiation with the excitation light emitted from the excitation light source.

With the arrangement, the light emitting device includes the light emitting element with a predetermined shape. Accordingly, upon irradiation with excitation light emitted from the excitation light source, the light emitting element can emit light whose luminous flux corresponds to the predetermined shape. Consequently, the light emitting device can achieve a high utilization ratio of light.

It is preferable that an illuminating device of the present invention includes the aforementioned light emitting device.

With the arrangement, the illuminating device includes the light emitting element with a predetermined shape (e.g. shape meeting a predetermined light distribution property required for the illuminating device). Since the light emitting element has such a shape, light emitted from the light emitting element is caused by the light emitting device to constitute luminous flux corresponding to the shape of the light emitting element, and is emitted to the outside of the illuminating device. Accordingly, the illuminating device can achieve a high utilization ratio of light.

It is preferable that a vehicle headlamp of the present invention includes the aforementioned light emitting device.

With the arrangement, the vehicle headlamp includes the light emitting element with a predetermined shape (e.g. shape meeting a predetermined light distribution property required for the vehicle headlamp). Since the light emitting element has such a shape, light emitted from the light emitting element is caused by the light emitting device to constitute luminous flux corresponding to the shape of the light emitting element, and is emitted to the outside of the vehicle headlamp. Accordingly, the vehicle headlamp can achieve a high utilization ratio of light.

### [Further Configuration (2) of the Present Invention]

Further, the light emitting device of the present invention may be expressed as follows based on Embodiments 1 and 2.

It is preferable to arrange the light emitting device of the present invention such that when seen from an incoming direction of the excitation light, one end of the heat conducting member which one end is positioned behind the irradiated region is shaped to include the irradiated region.

This arrangement enables efficiently collecting heat generated from the irradiated region of the light emitting part. Accordingly, it is possible to more effectively prevent an increase in the temperature of the irradiated region.

It is preferable to arrange the light emitting device of the present invention such that one end of the heat conducting member is embedded in the light emitting part in such a manner as to penetrate the light emitting part.

This arrangement enables efficiently collecting heat generated from the irradiated region of the light emitting part. Accordingly, it is possible to more effectively prevent an increase in the temperature of the irradiated region.

It is preferable to arrange the light emitting device of the present invention such that one end of the heat conducting member has a reflecting layer facing the irradiated surface of the light emitting part.

With the arrangement, excitation light entering the light emitting part is reflected by the reflecting layer so that the light is directed to the irradiated surface of the light emitting part again. This enables doubling the length of a path via which the excitation light is converted into fluorescence.

Accordingly, it is possible to increase a ratio of obtaining fluorescence from the light emitting part.

It is preferable to arrange the light emitting device of the present invention so as to further include at least one heat-releasing member positioned to surround the light emitting part except at the irradiated surface and a surface positioned oppositely to the irradiated surface, the one end of the heat conducting member contacting the at least one heat-releasing member.

With the arrangement, it is possible to more efficiently release heat from the heat conducting member.

It is preferable to arrange the light emitting device of the present invention so as to further include a cooling device, connected with the other end of the heat conducting member, for releasing heat from the heat conducting member.

With the arrangement, it is possible to more efficiently release heat from the heat conducting member.

It is preferable to arrange the light emitting device of the present invention such that the heat conducting member is made of a metal.

With the arrangement, a difference in thermal conductivity between the heat conducting member and the light emitting part is large, so that it is possible to more efficiently collect heat from the light emitting part.

It is preferable to arrange the light emitting device of the present invention such that the heat conducting member is made of a transparent material.

With the arrangement, light entering the light emitting part is transmitted in the light emitting element to a surface positioned oppositely to the surface via which the light enters. This enables obtaining more amount of fluorescence from the surface positioned oppositely to the surface via which the light enters.

It is preferable that an illuminating device of the present invention includes the aforementioned light emitting device.

With the arrangement, the illuminating device uses a light emitting device with a long life. Accordingly, the illuminating device can achieve high luminance and high reliability.

It is preferable that a vehicle headlamp of the present invention includes the aforementioned light emitting device.

With the arrangement, the vehicle headlamp uses a light emitting device with a long life. Accordingly, the vehicle headlamp can achieve high luminance and high reliability.

### [Another Expression of the Present Invention]

The present invention may be expressed as follows based on Embodiments 1 and 3 in particular.

The light emitting device of the present invention includes a light emitting part obtained by depositing, by electrophoresis, fluorescent materials on a surface of an electric conductor having the shape of a desired light emitting part. A structural characteristic of the light emitting part is that the fluorescent materials are deposited with substantially even thickness on the surface of the electric conductor.

In the light emitting part of the present invention, even when the shape of a conducting plate is simple rectangular, it is possible to pattern the conducting plate using an insulating material and form a fluorescent material film on a desired shape.

The light emitting element of the present invention may be arranged such that one side of the conducting plate is coated with an insulating layer.

The light emitting element of the present invention may be arranged such that individual sides of the conducting plate have insulating layers with different patterns.

The light emitting element of the present invention may be arranged such that the conducting plate is a transparent conducting film formed on a transparent substrate.

The light emitting element of the present invention may be arranged such that the conducting plate is a transparent conducting film formed on a mirror-finished substrate which reflects light.

The light emitting element of the present invention further includes a conducting terminal used when forming a fluorescent material film on the conducting plate by electrophoresis, and an insulator is applied to the surface of a minute portion (the terminal).

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention provides a light emitting element with high luminance and long life, which can be easily produced even if the light emitting element has a complex shape. The light emitting element is applicable to a vehicle headlamp for example. Further, the present invention is applicable to a light emitting device with high luminance and long life, in particular a headlamp for a vehicle etc.

### REFERENCE SIGNS LIST

1. Headlamp (light emitting device, illuminating device, vehicle headlamp)
2. Laser diode array (excitation light source)
3. Laser diode (excitation light source)
5. Optical fiber
5a. Exit end part
5b. Entrance end part
7. Light emitting part (light emitting element)
8. Reflection mirror
9. Transparent plate
40. Power source
70a. Laser beam-irradiated surface (light receiving surface)
75. Metal plate (conductive member)
76a-76d. Fluorescent material film
77. Conducting terminal
78. Insulating layer (insulating film)
79. ITO (conductive member)
81. Reflecting layer (light reflecting member)
90. Heat-releasing supporter (heat conducting member)
91. Cooling device
92a. First member
92b. Second member (reflecting layer)
100. Headlamp (light emitting device, illuminating device, vehicle headlamp)
200. Laser downlight (illuminating device)

1. A light emitting element, comprising:
a conductive member with a predetermined shape; and
at least one fluorescent material film on the conductive member, said at least one fluorescent material film being made by depositing on the conductive member a fluorescent material for emitting light upon irradiation with excitation light.

2. The light emitting element as set forth in claim 1, wherein the conductive member has a plate shape.

3. The light emitting element as set forth in claim 2, wherein said at least one fluorescent material film is made by depositing the fluorescent material on a region of the conductive member which region is other than an insulating film with a predetermined pattern covering a surface of the conductive member.

4. The light emitting element as set forth in claim 3, wherein
said at least one fluorescent material film includes two fluorescent material films, and the two fluorescent material films are formed on respective surfaces of the conductive member, and
when one of the respective surfaces is a first surface and the other is a second surface, the first surface and the second surface are coated with insulating films with different patterns.

5. The light emitting element as set forth in claim 2, wherein
said at least one fluorescent material film is formed on a light receiving surface of the conductive member, the light receiving surface being a surface receiving excitation light, and
an insulating film is formed on a surface of the conductive member which surface is positioned oppositely to the light receiving surface.

6. The light emitting element as set forth in claim 3, wherein the insulating film is made of an inorganic material.

7. The light emitting element as set forth in claim 2, wherein
said at least one fluorescent material film is formed on a light receiving surface of the conductive member, the light receiving surface being a surface receiving excitation light, and
a light reflecting member for reflecting light emitted from said at least one fluorescent material film is formed on a surface of the conductive member which surface is positioned oppositely to the light receiving surface.

8. The light emitting element as set forth in claim 1, wherein the conductive member is transparent.

9. The light emitting element as set forth in claim 1, wherein
the conductive member has a conducting terminal to be connected with a power source for forming said at least one fluorescent material film on the surface of the conductive member by electrophoresis, and
the conducting terminal is coated with an insulating film.

10. A light emitting device, comprising:
a light emitting element as set forth in claim 1; and
an excitation light source for emitting the excitation light,
the light emitting element emitting light upon irradiation with the excitation light emitted from the excitation light source.

11. A light emitting device, comprising:
a light emitting part including an irradiated surface including an irradiated area to be irradiated with excitation light; and
a heat conducting member having higher thermal conductivity than the light emitting part,
the heat conducting member having two ends, one end of which is embedded in the light emitting part in such a manner as to be positioned behind the irradiated region when seen from an incoming direction of the excitation light.

12. The light emitting device as set forth in claim 11, wherein when seen from an incoming direction of the excitation light, one end of the heat conducting member which one end is positioned behind the irradiated region is shaped to include the irradiated region.

13. The light emitting device as set forth in claim 11, wherein said one end of the heat conducting member is embedded in the light emitting part in such a manner as to penetrate the light emitting part.

14. The light emitting device as set forth in claim 11, wherein said one end of the heat conducting member has a reflecting layer facing the irradiated surface of the light emitting part.

15. The light emitting device as set forth in claim 11, further comprising at least one heat-releasing member positioned to surround the light emitting part except at the irradiated surface and a surface positioned oppositely to the irradiated surface,
said one end of the heat conducting member contacting said at least one heat-releasing member.

16. The light emitting device as set forth in claim 11, further comprising a cooling device, connected with the other end of the heat conducting member, for releasing heat from the heat conducting member.

17. The light emitting device as set forth in claim 11, wherein the heat conducting member is made of a metal.

18. The light emitting device as set forth in claim 11, wherein the heat conducting member is made of a transparent material.

19. An illuminating device, comprising a light emitting device as set forth in claim 10.

20. An illuminating device, comprising a light emitting device as set forth in claim 17.

21. A vehicle headlamp, comprising a light emitting device as set forth in claim 10.

22. A vehicle headlamp, comprising a light emitting device as set forth in claim 17.
